(19) United States
(12) Patent Application Publication
(10) Pub. No.: US 2021/0004848 A1
(43) Pub. Date: Jan. 7, 2021

(54) SERVER, MANAGEMENT DEVICE, AND MANAGEMENT SYSTEM

(71) Applicant: HONDA MOTOR CO.,LTD., Tokyo (JP)

(72) Inventors: Yoshihiro NAKAJIMA, Tokyo (JP); Shunichi HAGIYA, Tokyo (JP)

(21) Appl. No.: 17/023,421

(22) Filed: Sep. 17, 2020

Related U.S. Application Data
(63) Continuation of application No. PCT/JP2019/010389, filed on Mar. 13, 2019.

(30) Foreign Application Priority Data
Mar. 20, 2018 (JP) 2018-053378

(51) Int. Cl. G06Q 30/02; B60L 53/80

(52) U.S. Cl. CPC G06Q 30/0207; Y02T 90/16; B60L 53/80; G06Q 30/0283

(57) ABSTRACT

The management system includes a store terminal, a management device which is disposed in the station installed within a predetermined distance range from the store and manages the battery, a user terminal, and a server. When the store terminal detects that a user who possesses a user terminal which received an electronic coupon visits the store, it transmits, to at least one of the server and the management device, record information including information indicating a visit record.

The contents of the following Japanese patent applications are incorporated herein by reference:

NO. 2018-053378 filed in JP on Mar. 20, 2018

NO. PCT/JP2019/010389 filed on Mar. 13, 2019

### BACKGROUND

### 1. Technical Field

The present invention relates to a server, a management device, and a management system.

### 2. Related Art

There is known a system for controlling an electric vehicle, which provides a user of the electric vehicle with a suggestion such as a voucher and creates an energy plan to the charge station which is closest to the destination associated with the suggestion selected by the user (for example, see Patent document 1). When the user arrives at the destination, the system transmits tracking information indicating the arrival, to a control center. The service provider of the system receives an advertising income for the user arriving at the destination and also receives an advertising income for the user shopping in the business associated with the suggestion.

### PRIOR ART DOCUMENT

### Patent Document

[Patent document 1] Japanese Translation of PCT International Patent Application No. 2012-503468

### Problems to be Solved

However, although the above-mentioned system can be used to learn the arrival at the destination based on the tracking information, whether the shopping in the business associated with the suggestion has been done cannot be correctly learned.

### General Disclosure

In one aspect of the present invention, a management system is provided. The management system may include a store terminal. The store terminal may be provided at a store which sells products. The management system may include a management device. The management device may be disposed at a station which is installed within a predetermined distance range from the store and where a battery detachable to an electrically driven vehicle is exchanged, and manage the battery. The management system may include a user terminal. The user terminal may be possessed by a user of a vehicle. The management system may include a server. The server may communicate with a management device and a user terminal. The server may have a server-side transmitting section for transmitting, to the user terminal, an electronic coupon which includes useful information benefitting the user and which encourages the user to visit the store. The store terminal may have a store-side transmitting section which, when detecting that a user who possesses the user terminal which received the electronic coupon visits the store, transmits record information including the information indicating a visit record to at least one of the server and the management device.

The store-side transmitting section of the store terminal may, when detecting that the user who possesses the user terminal which received the electronic coupon uses the electronic coupon to purchase a product in the store, transmit the record information including information indicating a purchase record to at least one of the server and the management device.

The server may further have a billing section which obtains the record information from the store, calculates a consideration for attracting the user to the store based on the record information, and bills the store.

The predetermined distance range from the store may be the range of the premises of the store. The server further may have a calculating section which obtains the record information from the store, calculates the consideration for attracting the user to the store based on the record information, calculates a fee to be paid by the station to the store due to the station being installed within the range of the premises, and subtracts the consideration from the fee.

The user terminal may have an obtaining section to obtain location information indicating the location of the user terminal. The user terminal may have a displaying section which, in response to the user operation, displays an electronic coupon received from the server. The management device may have a detecting section which detects that a user who possesses the user terminal returns a battery used in a vehicle to the station in order to exchange it with a battery stocked in the station, and outputs return information indicating that the battery has been returned. The management device may have a managing and transmitting section which, upon receiving the return information from the detecting section, obtains from the user terminal the location information of the user terminal at a time when the electronic coupon is displayed on the displaying section of the user terminal, and transmits it to the server. The server may further have a location information storage section which stores installation location information indicating the information of the installation location where the station is installed. The server may further have an updating section which refers to the location information storage section and, when judging that the location of the user terminal indicated in the location information received from the management device is more than a predetermined distance away from the installation location of the station, transmits, from the server-side transmitting section to the user terminal, an instruction to update the useful information included in the electronic coupon transmitted to the user terminal to an even more beneficial one for the user.

The user terminal may have a communication section which communicates with the server. The user terminal may have an obtaining section which obtains location information indicating the location of the user terminal. The user terminal may also have a displaying section which, in response to a user operation, displays an electronic coupon received from the server. The management device may have a detecting section which detects that a user who possesses the user terminal returns a battery used in a vehicle to the station in order to exchange it with a battery stocked in the station and outputs return information indicating that the battery has been returned. The management device may have a managing and transmitting section which transmits, to the server, the return information received from the detecting section. The electronic coupon may be configured to be associated with the location information at a present time obtained by the obtaining section of the user terminal and be transmitted from the communication section in the user terminal to the server, in response to being displayed on the displaying section of the user terminal. The server may further have a location information storage section which stores installation location information indicating the information of the installation location where the station is installed. The server may further have an updating section which, upon receiving return information from the management device, refers to the location information storage section and, when judging that the location of the user terminal indicated in the location information associated with the electronic coupon received from the user terminal is more than a predetermined distance away from the installation location of the station, transmits, from the server-side transmitting section to the user terminal, an instruction to update the useful information included in the electronic coupon transmitted to the user terminal to an even more beneficial one for the user.

The management device may further have a history storage section which stores exchange history information indicating a history of exchanges of the battery at the station. The management device may further have a detecting section which detects that a user who possesses the user terminal returns a battery used in a vehicle to the station in order to exchange it with a battery stocked in the station and outputs return information indicating that the battery has been returned. The management device may further have a managing and transmitting section which obtains the exchange history information from the history storage section, transmits it to the server, and transmits, to the server, the return information received from the detecting section. The server may further have a time-predicting section which predicts a time slot during which the number of the batteries stocked in the station is larger than a predetermined number, based on the exchange history information received from the management device. The server may further have an updating section which, when judging that the time when the return information is received from the management device is in the time slot predicted by the time-predicting section, transmits, from the server-side transmitting section to the user terminal, the instruction to update the useful information included in the electronic coupon transmitted to the user terminal to an even more beneficial one for the user.

The management device may further have a history storage section which stores exchange history information indicating a history of exchanges of the battery at the station. The management device may further have a managing and transmitting section which obtains exchange history information from the history storage section and transmits it to the server. The server may further have a time-predicting section which predicts a time slot during which the number of the batteries stocked in the station is larger than a predetermined number, based on the exchange history information received from the management device. The server may further have a setting section which sets, to the electronic coupon, the expiration time corresponding to the time slot predicted by the time-predicting section.

The battery used in the vehicle may have usage history information written thereto, which indicates how the battery has been used during a period from the moment when it was mounted to the vehicle to the moment when it was removed. The management device may further have a managing and transmitting section which reads the usage history information from the battery used in the vehicle and returned by the user to the station in order to exchange a battery stocked in the station, and transmits it to the server. The server may further have an adjusting section which transmits, from the server-side transmitting section to the user terminal, an instruction to adjust useful information included in the electronic coupon which has been transmitted to the user terminal based on the usage history information received from the management device.

The server may further have a standard storage section which stores reference information which indicates a reference range of the usage amount of the battery. The adjusting section may refer to the standard storage section, and, when judging that the usage amount of the battery indicated in the usage history information received from the management device is within a reference range, transmit, from the server-side transmitting section to the user terminal, an instruction to update the useful information included in the electronic coupon transmitted to the user terminal to an even more beneficial one for the user.

The battery used in the vehicle may have path history information written thereto, which indicates the history of the path along which the vehicle travels. The management device may further have a managing and transmitting section which reads the path history information from the battery used in the vehicle and returned by the user to the station in order to exchange a battery stocked in the station, and transmits it to the server. The server may further have a route-predicting section which predicts the path along which the vehicle travels based on the path history information received from the management device. The server-side transmitting section of the server may transmit, to the user terminal, an electronic coupon which encourages the user to visit the store within a predetermined distance range from the path along which the vehicle will travel, predicted by the route-predicting section.

The battery used in the vehicle may have station history information written thereto, which indicates the history of the station utilized by the user to exchange the battery. The management device may further have a managing and transmitting section which reads the station history information from the battery used in the vehicle and returned by the user to the station in order to exchange a battery stocked in the station, and transmits it to the server. The server may further have a station predicting section which predicts the station utilized by the user based on the station history information received from the management device. The server-side transmitting section of the server may transmit, to the user terminal, an electronic coupon which encourages the user to visit the store within a predetermined distance range from the station that the station predicting section predicts the user will utilize.

The server may further have a determining section which receives stock number information indicating the number of batteries stocked in the station from the management device and determines the number of issuance of the electronic coupon depending on the number of the batteries indicated by the stock number information. The server may further have an issuing section which issues the electronic coupon according to the number of issuance determined by the determining section.

In one aspect of the present invention, a management system is provided, which includes a store terminal provided in a store selling products; a management device which is disposed in a station installed within a predetermined distance range from the store, wherein a battery detachable to an electrically driven vehicle is exchanged in the station, and which manages the battery; a user terminal possessed by a user of the vehicle; and a server which communicates with the management device. When the management device detects that the user possessing the user terminal exchanges the battery of the vehicle at the station, it transmits, to the user terminal, an electronic coupon which encourages the user to visit the store. When the store terminal detects that the user possessing the user terminal which received the electronic coupon visits the store, it transmits record information including the information indicating a visit record to at least one of the server and the management device.

In one aspect of the present invention, a server is provided, which is configured to communicate with a management device and a user terminal, the management device being configured to manage a battery detachable to a vehicle which is electrically driven, and the user terminal being possessed by a user of the vehicle, wherein the management device is disposed in a station where the battery is exchanged and which is installed within a predetermined distance range from the store which sells products,

the server comprising:

a time-predicting section which is configured to receive, from the management device, exchange history information indicating a history of exchanges of the battery at the station and predict a time slot during which a number of the battery stocked in the station is larger than a predetermined number, based on the exchange history information;

a setting section which is configured to set an expiration time corresponding to the time slot predicted by the time-predicting section to an electronic coupon including useful information which is beneficial for the user, wherein the electronic coupon encourages the user to visit the store; and

a transmitting section which is configured to transmit, to the user terminal, the electronic coupon to which the expiration time is set by the setting section.

In one aspect of the present invention, a server is provided, which is configured to communicate with a management device and a user terminal, the management device being configured to manage a battery detachable to a vehicle which is electrically driven, and the user terminal being possessed by a user of the vehicle, wherein the management device is disposed in a station where the battery is exchanged and which is installed within a predetermined distance range from the store which sells products, and

the battery used in the vehicle has usage history information written thereto, which indicates how the battery has been used during a period from a moment when the battery was mounted to the vehicle to a moment when the battery was removed,

the server comprising:

a transmitting section which is configured to transmit, to the user terminal, an electronic coupon including useful information which is beneficial for the user, wherein the electronic coupon encourages the user to visit the store; and an adjusting section which is configured to receive, from the management device, the usage history information read by a battery used in the vehicle and returned by the user to the station in order to exchange the battery with the battery stocked in the station and transmit, from the transmitting section to the user terminal, an instruction to adjust the useful information included in the electronic coupon transmitted to the user terminal, based on the usage history information.

The server may further include a standard storage section which stores reference information which indicates a reference range of the usage amount of the battery. The adjusting section may refer to the standard storage section, and, when judging that the usage amount of the battery indicated in the usage history information received from the management device is within a reference range, transmit, from the transmitting section to the user terminal, an instruction to update the useful information included in the electronic coupon transmitted to the user terminal to an even more beneficial one for the user.

In one aspect of the present invention, a server is provided, which is configured to communicate with a management device and a user terminal, the management device being configured to manage a battery detachable to a vehicle which is electrically driven, and the user terminal being possessed by a user of the vehicle, wherein the management device is disposed in a station where the battery is exchanged and which is installed within a predetermined distance range from a store which sells products,

the server comprising:

a determining section which is configured to receive, from the management device, stock number information indicating a number of the battery stocked in the station, and determine a number of issuance of an electronic coupon including useful information which is beneficial for the user depending on the number of the battery indicated in the stock number information, wherein the electronic coupon encourages the user to visit the store; and a transmitting section which is configured to issue the electronic coupon according to the number of issuance which is determined by the determining section and transmit it to the user terminal.

In one aspect of the present invention, a management device is provided, which is configured to manage a battery detachable to a vehicle which is electrically driven, wherein

the management device is disposed in a station where the battery is exchanged and which is installed within a predetermined distance range from a store which sells products, and includes:

a time-predicting section which is configured to obtain exchange history information indicating a history of exchanges of the battery at the station, and predict a time slot during which a number of the battery stocked in the station is larger than a predetermined number based on the exchange history information;

a setting section which is configured to set, to an electronic coupon including a useful information which is beneficial for a user of the vehicle, an expiration time corresponding to the time slot which is predicted by the time-predicting section, wherein the electronic coupon encourages the user to visit the store; and a transmitting section which is configured to transmit, to a user terminal possessed by the user, the electronic coupon to which the expiration time is set by the setting section.

In one aspect of the present invention, a management device is provided, which is configured to manage a battery detachable to a vehicle which is electrically driven, wherein

the battery used in the vehicle has usage history information written thereto, which indicates how the battery has been used during a period from a moment when the battery was mounted to the vehicle to a moment when the battery was removed,

the management device is disposed in a station where the battery is exchanged and which is installed within a predetermined distance range from a store which sells products, and includes:

a transmitting section which is configured to issue an electronic coupon including useful information which is beneficial for a user of the vehicle and transmit it to a user terminal possessed by the user, wherein the electronic coupon encourages the user to visit the store;

a reading section which is configured to read the usage history information from a battery used in the vehicle and returned by the user to the station in order to exchange the battery with the battery stocked in the station; and

an adjusting section which is configured to transmit, from the transmitting section to the user terminal, an instruction to adjust the useful information included in the electronic coupon transmitted to the user terminal, based on the usage history information read by the reading section.

The management device may further include a standard storage section which stores reference information indicating a reference range of a usage amount of a battery. The adjusting section may refer to the standard storage section, and, when judging that the usage amount of the battery indicated in the usage history information read by the reading section is within a reference range, transmit, from the transmitting section to the user terminal, the instruction to update the useful information included in the electronic coupon transmitted to the user terminal to an even more beneficial one for the user.

In one aspect of the present invention, a management device is provided, which is configured to manage a battery detachable to a vehicle which is electrically driven, and is disposed in a station where the battery is exchanged and which is installed within a predetermined distance range from a store which sells products, the management device comprising:

a determining section which is configured to obtain stock number information indicating a number of the battery stocked in the station, and determine a number of issuance of an electronic coupon including useful information which is beneficial for a user of the vehicle depending on the number of the battery indicated in the stock number information, wherein the electronic coupon encourages the user to visit the store; and

a transmitting section which is configured to issue the electronic coupon according to the number of issuance determined by the determining section and transmit it to a user terminal possessed by the user.

The summary clause does not necessarily describe all necessary features of the embodiments of the present invention. The present invention may also be a sub-combination of the features described above.

### BRIEF DESCRIPTION OF THE DRAWINGS

FIG. 1 is a schematic diagram of a management system 20 according to the first embodiment.

FIG. 2 is a block diagram of a vehicle 100 according to the first embodiment.

FIG. 3 is a block diagram of a battery 200 according to the first embodiment.

FIG. 4 is one example of a table of the driving information history information stored in the driving history storage section 213 according to the first embodiment.

FIG. 5 shows one example of a table of the usage situation history information which stores the usage situation history storage section 215 according to the first embodiment.

FIG. 6 is a block diagram of a communication terminal 70 according to the first embodiment.

FIG. 7 is a block diagram of the station 300 according to the first embodiment.

FIG. 8 is a block diagram of the management device 400 according to the first embodiment.

FIG. 9 is a block diagram of the store terminal 32 according to the first embodiment.

FIG. 10 is a block diagram of the server 500 according to the first embodiment.

FIG. 11 is a flow diagram according to the first embodiment.

FIG. 12 is a flow diagram according to the second embodiment.

FIG. 13 is one example of a table of the exchange history information stored in a history storage section 427 of a management device 400 according to the third embodiment.

FIG. 14 is one example of a table of the station history information stored in a station history storage section 216 of a battery 200 according to the fourth embodiment.

FIG. 15 is one example of a table of the path history information stored in a driving history storage section 213 of the battery 200 according to the fifth embodiment.

FIG. 16 is a block diagram of a management device 600 according to the sixth embodiment.

FIG. 17 is a block diagram of a server 700 according to the sixth embodiment.

FIG. 18 is a diagram which shows an example of a computer 1200 in which a plurality of aspects of the present invention is wholly or partially embodied.

### DESCRIPTION OF EXEMPLARY EMBODIMENTS

Hereinbelow, the present invention will be described through embodiments of the invention, but the following embodiments do not limit the invention disclosed in claims. In addition, not all combinations of features described in the embodiments necessarily have to be essential to solving means of the invention. Identical or similar portions in figures are given identical reference numbers, and the same explanation is omitted in some cases.

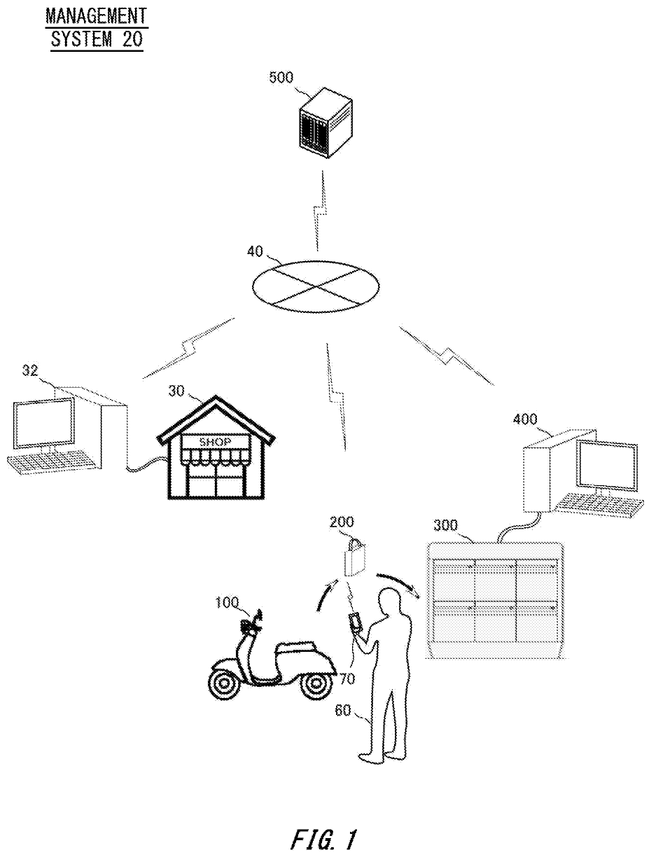

FIG. 1 is a schematic diagram of the management system 20 according to the first embodiment. The management system 20 manages the battery 200 detachable to the vehicle 100 which is electrically driven.

The management system 20 includes a vehicle 100 used by a user 60, the battery 200 which charges/discharges electrical power with the vehicle 100 while it is mounted to the vehicle 100, and a station 300 which accommodates and charges/discharges a plurality of batteries 200. The management system 20 further includes a management device 400 which manages the battery 200 and a store terminal 32 which is provided in a store 30 which sells products. The station 300 and the vehicle 100 communicate with the battery 200 through wireless communication means or wired communication means. The management device 400 obtains the information of the vehicle 100 via the battery 200 and the station 300.

The management system 20 further includes a communication terminal 70 which is possessed by the user 60. The communication terminal 70 is, for example, a smartphone, and communicates with the server 500 via a communication network 40. The communication terminal 70 further communicates with the battery 200 through short distance wireless communication means such as Bluetooth (registered trademark).

The station 300 accommodates and charges the battery 200 to be used in the vehicle 100. Furthermore, the station 300 lends the battery 200 to the user 60. The station 300 is installed within a predetermined distance range from the store 30, for example, within a range of the premises of the store 30.

The management device 400 is, for example, a PC, and is disposed in the station 300 or manages the station 300 remotely. Specifically, the management device 400 controls charging, lending, and discharging, for an outside electrical power company, of the battery 200 accommodated in the station 300. Furthermore, the management device 400 transmits, to the server 500, the information obtained from the battery 200 via the station 300.

The server 500 includes useful information which is beneficial for the user 60, and transmits, to the communication terminal 70, an electronic coupon which encourages the user to visit the store 30. If the user 60 visits the store 30 after seeing the electronic coupon, a consideration for the effect of attracting the user to the store 30 is paid by the store 30 to the operator of the station 300. Furthermore, if the user 60 actually purchases a product at the store 30 using the electronic coupon, a further consideration for the effect of increasing the sales at the store 30 is paid by the store 30 to the operator of the station 300.

In the present embodiment, the vehicle 100 is a motorcycle. Alternatively or additionally, the vehicle 100 may be an automobile, an electric bicycle, or the like.

In the present embodiment, the user 60 is a member registered in the management company of the management system 20. The server 500 centrally manages the user ID and the IP address, MAC address, email address, or the like of the communication terminal 70 for all the members in advance. The user ID is an ID for identifying an individual of the user 60. Thus, the server 500 can transmit the above-mentioned voucher to the communication terminal 70 of any member. It is noted that if the user ID is the IP address, MAC address, or email address itself of the communication terminal 70, alternatively, the server 500 may centrally manage only the user ID for all the members.

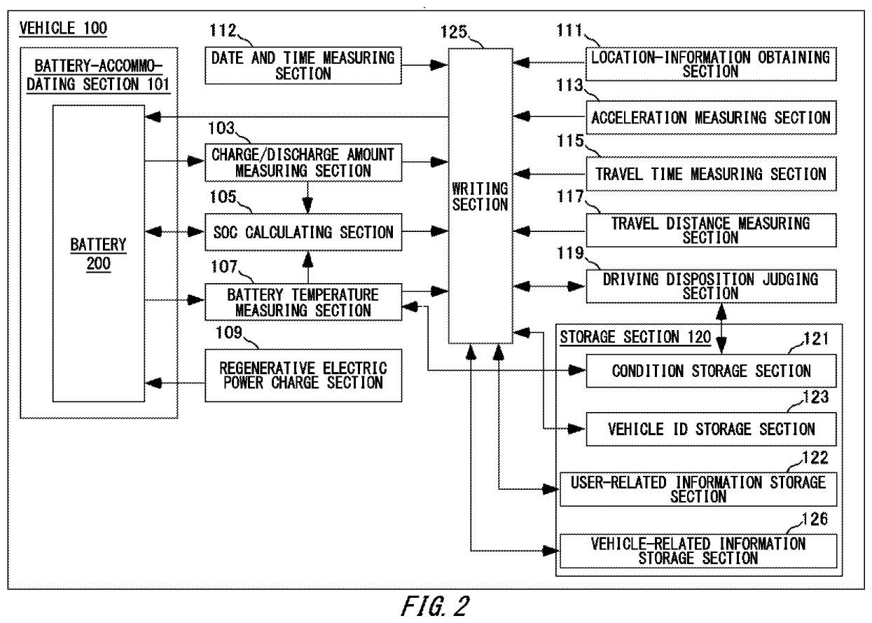

FIG. 2 is a block diagram of the vehicle 100. The vehicle 100 includes a battery-accommodating section 101 to accommodate the battery 200, and a storage section 120 including a condition storage section 121, a user-related information storage section 122, a vehicle-related information storage section 126, and a vehicle ID storage section 123. The battery-accommodating section 101 accommodates the battery 200 and is electrically connected thereto.

The condition storage section 121 stores a driving disposition judging condition to judge driving disposition of the user 60 of the vehicle 100, a SOC (State of Charge) condition within an appropriate range for the battery 200, and a temperature condition within an appropriate range for the battery 200. The SOC condition within an appropriate range includes that the SOC is not below a predetermined appropriate lower limit SOC. The temperature condition within an appropriate range includes that the temperature is not above a predetermined appropriate upper limit temperature and not below a predetermined appropriate lower limit temperature.

The vehicle ID storage section 123 stores a vehicle ID to identify the individual of the vehicle 100. The vehicle ID includes, for example, VIN (Vehicle Identification Number).

The user-related information storage section 122 stores the user-related information related to the user 60 who uses the vehicle 100. The vehicle-related information storage section 126 stores the vehicle-related information related to the vehicle 100.

The vehicle-related information includes a vehicle ID, vehicle class information indicating the vehicle class of the vehicle 100, home base location information indicating the location of home base where the vehicle 100 is used, or the like. The user-related information includes a user ID, user address information indicating the user address of the user 60, or the like.

The vehicle 100 further includes a charge/discharge amount measuring section 103 and a battery temperature measuring section 107. The charge/discharge amount measuring section 103 measures the current flowing into/out of the battery 200 and the voltage of the battery 200, integrates the current and the voltage to calculate the electrical power amount, and outputs it to the writing section 125. The battery temperature measuring section 107 measures the temperature of the battery 200 and outputs it to the writing section 125.

The vehicle 100 further includes a regenerative electric power charge section 109 which charges the battery 200 with regenerative electrical power generated in the vehicle 100 due to the brake operation of the battery 200.

The vehicle 100 further includes a SOC calculating section 105 which calculates the SOC.

The SOC calculating section 105 calculates the SOC of the battery 200 when it receives the voltage of the battery 200 from the charge/discharge amount measuring section 103 and receives the temperature of the battery 200 from the battery temperature measuring section 107.

More specifically, assuming that measured data such as a premeasured no-load discharge property (OCV [Open Circuit Voltage]) of the battery 200, temperature characteristics, and a SOC-OCV curve of the battery 200 premeasured under a particular condition is written to the battery 200 as a reference, the SOC calculating section 105 reads the measured data written to the battery 200. The SOC calculating section 105 continuously captures the impedance of the battery 200 in the impedance-track manner by using the voltage and temperature of the battery 200 received from the charge/discharge amount measuring section 103 and the battery temperature measuring section 107 and the measured data read from the battery 200 and writes it to the battery 200 to update the SOC-OCV curve read from the battery 200. The SOC calculating section 105 calculates the current SOC of the battery 200 based on the updated SOC-OCV curve and the current voltage of the battery 200 received from the charge/discharge amount measuring section 103 and outputs it to the writing section 125. The SOC calculating section 105 also refers to the condition storage section 121 to judge whether the SOC of the battery 200 during a mount period, which is a period from the moment when the battery 200 is mounted to the vehicle 100 and to the moment when it is removed, is within an appropriate range and outputs the result to the writing section 125.

The vehicle 100 further includes a date and time measuring section 112 which measures the current date and time and outputs them to the writing section 125, a location-information obtaining section 111 which obtains the location information of the vehicle 100 at a present time and outputs it to the writing section 125, and an acceleration measuring section 113 which measures the acceleration of the vehicle 100 and outputs it to the writing section 125.

The location-information obtaining section 111 obtains GPS data representing the longitude and latitude of the location of the vehicle 100 from, for example, the GPS (Global Positioning System) and outputs the area including the location of the vehicle 100 indicated by the GPS data, for example, area A, area B, and the like, as the location information of the vehicle 100 at a present time. The location-information obtaining section 111 also outputs the obtained GPS data itself as the location information of the vehicle 100 at a present time.

The date and time measuring section 112 measures and outputs the time slot and a day of the week of one drive cycle, which is, for example, from the moment when the ignition switch of the vehicle 100 is turned on to the moment when it is turned off.

The vehicle 100 further includes a travel time measuring section 115 which measures a continuous travel time per one drive cycle of the vehicle 100 and outputs it to the writing section 125 and a travel distance measuring section 117 which measures a continuous travel distance per one drive cycle of the vehicle 100 and outputs it to the writing section 125.

The vehicle 100 further includes a driving disposition judging section 119 which judges the driving disposition of the user 60 of the vehicle 100 based on the information received from the writing section 125 and the driving disposition judging condition stored in the condition storage section 121 and outputs the result to the writing section 125. The driving disposition judging section 119 judges which of the acceleration-oriented disposition, energy-saving-oriented disposition, long distance-oriented driving disposition, long time-oriented driving disposition, short distance-oriented driving disposition, or short time-oriented driving disposition the driving disposition corresponds to, based on the driving disposition judging condition.

The above-mentioned writing section 125 writes a plurality of pieces of information received from each component of the vehicle 100 to the battery 200, along with the vehicle ID stored in the vehicle ID storage section 123, the user-related information stored in the user-related information storage section 122, and the vehicle-related information stored in the vehicle-related information storage section 126.

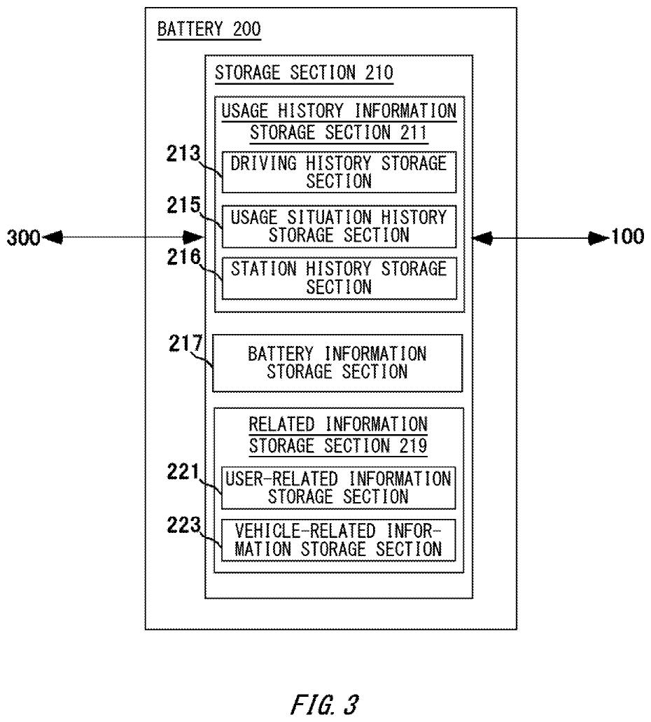

FIG. 3 is a block diagram of the battery 200. The battery 200 is a so-called mobile battery, which can be carried by the user 60 after it is removed from the vehicle 100.

The battery 200 includes a storage section 210 which stores a plurality of types of information or the like received from the vehicle 100. The storage section 210 includes a usage history information storage section 211 which stores the usage history information of the battery 200, a battery information storage section 217 which stores the battery information related to the battery 200, and a related information storage section 219 which stores the related information of the battery 200 used in the vehicle 100.

The usage history information indicates how the battery 200 has been used in the vehicle 100 during the mount period of the battery 200 to the vehicle 100. The usage history information includes driving history information indicating the driving history of the vehicle 100, the usage situation history information indicating the history of the usage situation of the battery 200, and station history information. Correspondingly, the usage history information storage section 211 includes a driving history storage section 213 which stores the driving history information, a usage situation history storage section 215 which stores usage situation history information, and a station history storage section 216 which stores station history information.

The driving history information includes, for example, path history information indicating a history of the path along which the vehicle 100 travels during the mount period of the battery 200. In addition, the driving history information includes, for example, history information such as a continuous travel distance, a continuous travel time, a number of sudden accelerations and decelerations, a travel time slot, a travel day of the week, and a travel area per one drive cycle of the vehicle 100 during the mount period of the battery 200, as well as an accumulated travel distance, an accumulated travel time, or the like of all drive cycles during the mount period of the battery 200. The driving history information further includes the above-mentioned driving disposition.

The usage situation history information includes, for example, the history information such as the date and time when the battery 200 is mounted, and the SOC, charge amount, and discharge amount of the battery 200, the number of times that the temperature of the battery 200 becomes equal to or more than a predetermined appropriate upper limit temperature, or the number of times that the temperature of the battery 200 becomes equal to or less than a predetermined appropriate lower limit temperature during the mount period of the battery 200. The usage situation history information includes the information indicating whether the SOC of the battery 200 during the mount period of the battery 200 is within the appropriate range and the information is judged and written by the vehicle 100 as described above.

The usage situation history information may include the temperature history itself of the battery 200 during the mount period of the battery 200. In addition, the usage situation history information may include not only the information which relates to the travel of the vehicle 100 during the mount period of the battery 200, but also the information which does not relate to the travel of the vehicle 100 during the period, for example, the information due to the self-discharge and the aging deterioration of the battery 200, or the like. In addition, the usage situation history information may include the information during the mount period of the battery 200, such as deterioration degree (SOH [State of Health]) indicating the degree of deterioration of the battery 200, the deterioration class indicating the deterioration degree in a stepwise manner, and the change of the deterioration class, and the information is judged and written by the management device 400. Alternatively, the information of the deterioration degree may be calculated by the vehicle 100 during the travel of the vehicle 100.

Herein, the deterioration degree (SOH) of the battery 200 is represented as a remained capacity ratio, that is, the ratio as a percentage of the capacity of the battery 200 in the current state of the battery 200 to the capacity of the battery 200 in the unused state of the battery 200. The deterioration degree (SOH) can also be defined as a value of the ratio of the current capacity to the nominal capacitance of the battery 200, represented as a percentage.

In addition, the usage situation history information may include the information indicating whether the deterioration degree of the battery 200 during the mount period of the battery 200 is within the appropriate range, and the information is judged and is written by the management device 400.

The station history information indicates the history of the station 300 which was utilized by the user 60 to exchange the battery 200. The station history information may be the information of a plurality of stations 300 which is ranked in the descending order of the frequency with which the user 60 utilizes the stations.

The battery information stored in the battery information storage section 217 includes the battery ID for identifying the individual of the battery 200. The battery information further includes measured data such as a premeasured no-load discharge property (OCV) of the battery 200, temperature characteristics, a SOC-OCV curve of the battery 200 premeasured under a particular condition, or the like. The battery information may also include a nominal capacitance of the battery 200 measured under a particular condition. In addition, the battery information may further include the information of the type of the battery 200, the information of the current maximum allowable current, maximum allowable voltage, and maximum allowable temperature of the battery 200, or the like. The information such as the current maximum allowable current, maximum allowable voltage and maximum allowable temperature of the battery 200 is preferably measured by the vehicle 100 while the vehicle 100 travels. The information of the SOC of the battery 200 stored in the usage situation history storage section 215 and the information of the current deterioration degree of the battery 200 may also be used as the battery information.

The related information storage section 219 includes a user-related information storage section 221 which stores the user-related information related to the user 60 who uses the vehicle 100 with the battery 200 mounted, and a vehicle-related information storage section 223 which stores the vehicle-related information related to the vehicle 100 with the battery 200 mounted. The user-related information and the vehicle-related information are written by the vehicle 100.

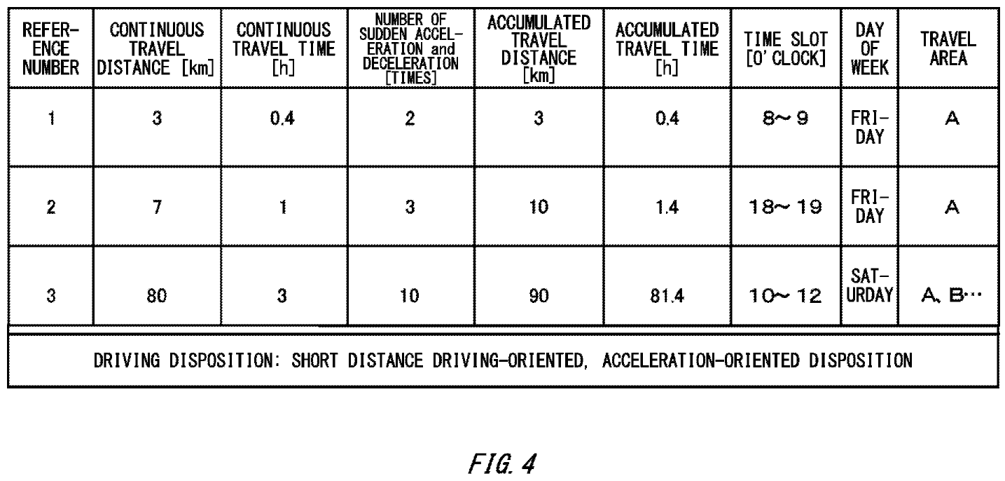

FIG. 4 is one example of the table of the driving information history information stored in the driving history storage section 213. In this table, “reference number”, “continuous travel distance [km]”, “continuous travel time [h]”, “number of sudden accelerations and decelerations [number of times]”, “accumulated travel distance [km]”, “accumulated travel time [h]”, “time slot [o'clock]”, “day of the week”, and “travel area” are recorded in association with each other. The table is recorded per user ID (or vehicle ID) and the “driving disposition” is recorded per table.

For example, in the row of reference number 1, the continuous travel distance is recorded as 3 km, the continuous travel time as 0.4 h, the number of sudden accelerations and decelerations as twice, the accumulated travel distance as 3 km, the accumulated travel time as 0.4 h, the time slot as 8-9 o'clock, the day of the week as Friday, and the travel area as A. Furthermore, a result is stored in which the driving disposition of the user 60 who borrows the battery 200 and uses the vehicle 100 is judged as the short distance-oriented driving disposition and acceleration-oriented disposition based on the driving history data the three drive cycles from reference number 1 to 3.

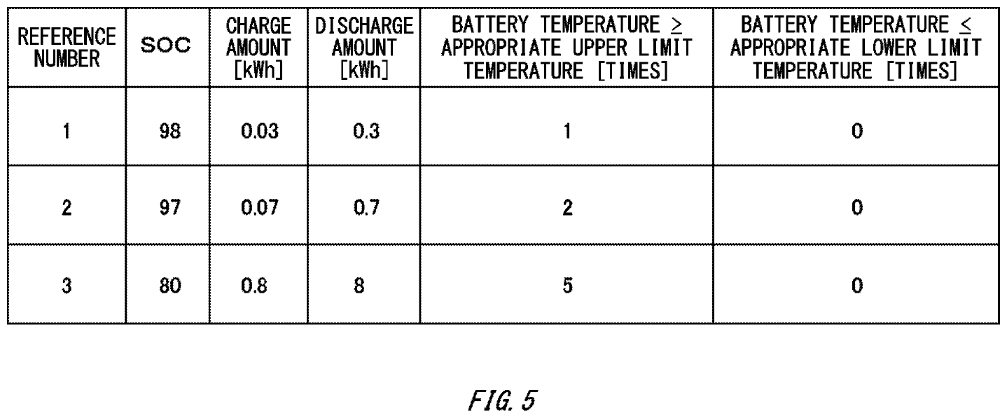

FIG. 5 shows one example of a table of the usage situation history information stored in the usage situation history storage section 215. The table associates and records “reference number”, “SOC”, “charge amount [kWh]”, “discharge amount [kWh]”, “battery temperature≥appropriate upper limit temperature [number of times]”, and “battery temperature≤appropriate lower limit temperature [number of times]”.

For example, the row of reference number 1 records the SOC as 98, the charge amount as 0.03 kWh, the discharge amount as 0.3 kWh, the number of times that battery temperature≥appropriate upper limit temperature is met as one, the number of times that battery temperature≤appropriate lower limit temperature is met as zero. It is noted that the reference numbers described at the left end of each table in FIG. 4 and FIG. 5 correspond with each other. That is, the data indicated with the same reference number is the data in the same one drive cycle.

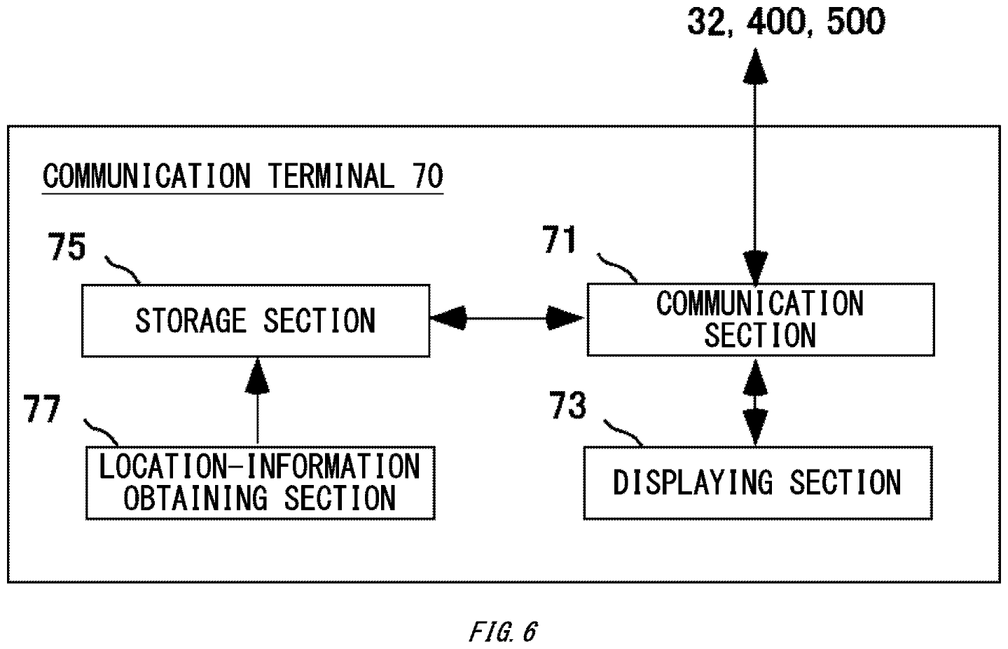

FIG. 6 is a block diagram of the communication terminal 70. The communication terminal 70 includes a communication section 71 which communicates with the store terminal 32, the management device 400, and the server 500, a displaying section 73 which displays the electronic coupon or the like distributed from the server 500, a storage section 75 which stores the electronic coupon or the like distributed from the server 500, and a location-information obtaining section 77 which obtains the location information of the communication terminal 70 at a present time and cumulatively stores it to the storage section 75.

The location-information obtaining section 77 has the functions similar to those of the location-information obtaining section 111 in the vehicle 100, and the explanation is omitted. When the communication section 71 receives, from the management device 400, a signal which requests the location information of the communication terminal 70 at the time when the electronic coupon is displayed on the displaying section 73 of the communication terminal 70, it reads the location information from the storage section 75 and transmits it to the management device 400.

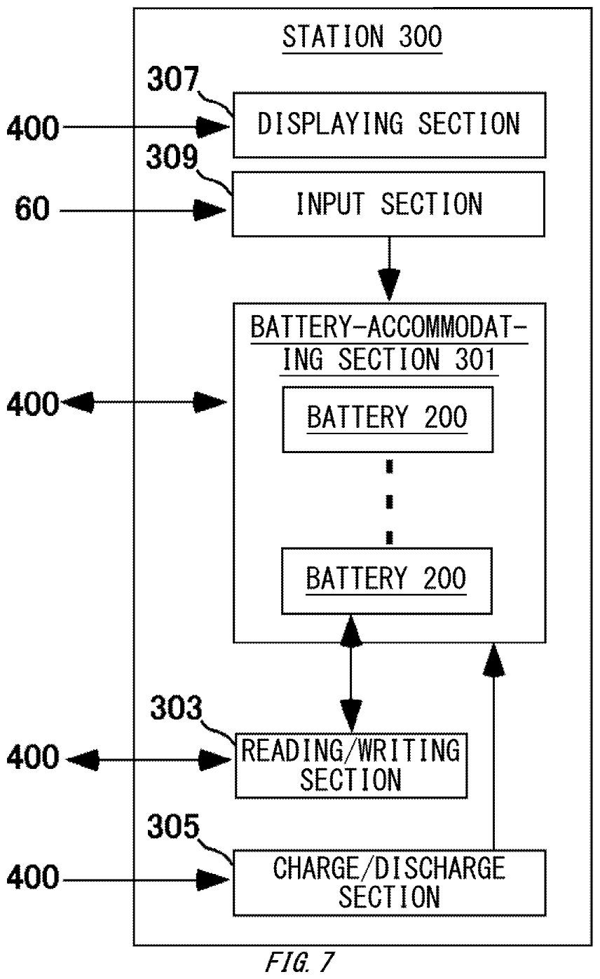

FIG. 7 is a block diagram of the station 300. The station 300 includes a battery-accommodating section 301 which accommodates a plurality of the batteries 200, a reading/writing section 303 which performs reading and writing on the plurality of batteries 200 accommodated in the battery-accommodating section 301, and a charge/discharge section 305 which controls the charges/discharges of the battery 200 according to the instruction from the management device 400.

Based on the instruction from the management device 400, the battery-accommodating section 301 enables a particular accommodated battery 200 to be lendable, that is, to be taken out from the outside. In addition to enable the particular accommodated battery 200 to be taken out from the outside, the battery-accommodating section 301 may, for example, flash the LED provided in the accommodating location of the battery 200 so that the accommodating location can be easily identified from the outside.

Upon detecting that the battery 200 has been accommodated in the battery-accommodating section 301, the reading/writing section 303 reads the information of the battery 200 and outputs it to the management device 400. In addition, the reading/writing section 303 writes the information received from the management device 400 to the battery 200 based on the instruction from the management device 400.

The station 300 further includes a displaying section 307 which displays the information input from the management device 400 and an input section 309 which accepts the input from the user 60. The displaying section 307 and the input section 309 may be an integrated touch panel. In addition, the input section 309 may be a push button disposed independent of the displaying section 307.

The displaying section 307 may display a list of, for example, the deterioration class and price of a plurality of batteries 200 to the user 60 who has returned the battery 200. The displaying section 307 may visually inform the user 60 of the accommodating location of the battery 200 which is recommended or selected by the management device 400, for example by displaying an image of the battery-accommodating section 301 and flashing a particular accommodating location in the image.

The displaying section 307 may display the reward information itself received form the management device 400. In this case, it may cause the communication terminal 70 of the user 60 to display the reward information, for example by displaying a barcode for the communication terminal 70 to read.

The input section 309 outputs, to the management device 400, the information received from the user 60 who returns the battery 200. The input section 309 may accepts the lending of a particular battery 200 which is accommodated in the battery-accommodating section 301.

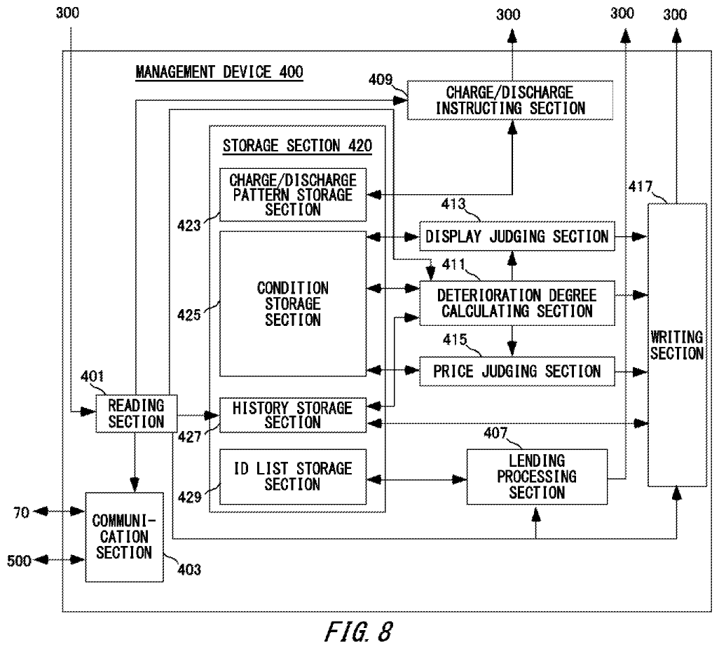

FIG. 8 is a block diagram of the management device 400. The management device 400 includes a reading section 401 which reads the information of the battery 200 from the battery 200 stocked in the station 300, and a storage section 420 which stores a plurality of types of information.

The reading section 401 outputs, to the station 300, the instruction to read the information of the battery 200 returned by the user 60. The reading section 401 detects that the user 60 who possesses the communication terminal 70 returns the battery 200 used in the vehicle 100 to the station 300 to exchange it to the battery 200 stocked in the station 300, and then outputs the return information indicating that the battery has been returned. The reading section 401 is one example of the detecting section.

The storage section 420 includes a charge/discharge pattern storage section 423 which stores the charge/discharge pattern corresponding to the battery information, and a condition storage section 425 which stores a plurality of judging conditions.

The condition storage section 425 stores a deterioration class condition used to judge, based on the deterioration degree of the battery 200, the deterioration class which indicates the deterioration degree of the battery 200 in a stepwise manner. For example, the deterioration class condition includes that, as the relationship between the deterioration degree (SOH) and the deterioration class, the deterioration class is 1 when SOH=91 to 100, the deterioration class is 2 when SOH=81 to 90, the deterioration class is 3 when SOH=71 to 80, the deterioration class is 4 when SOH=61 to 70, the deterioration class is 5 when SOH=51 to 60, and the deterioration class is unusable when SOH≤50. It is noted that the management device 400 may judge an unusable battery 200 to be a target for collection. The condition storage section 425 further stores the deterioration degree condition within the appropriate range of the battery 200. The deterioration degree condition within the appropriate range includes that a deterioration degree is not below a predetermined appropriate lower limit deterioration degree.

The storage section 420 further includes a history storage section 427 which stores the accumulated usage history information which is the information obtained by accumulating the usage history information read by the reading section 401 from the battery 200 returned to the station 300 in association with the battery ID of the battery 200. The history storage section 427 may store the vehicle ID of the vehicle 100 with the battery 200 mounted and the usage history information during the period when the battery was used in the vehicle 100 in association with the battery ID.

The storage section 420 further includes an ID list storage section 429 which stores a list of a plurality of IDs. The ID list storage section 429 stores a vehicle ID list of the vehicle ID and a user ID list of the user ID for which the stocked battery 200 can be lent. The ID list storage section 429 may further store a battery ID list of the battery ID for which the stocked battery 200 can be lent.

The management device 400 further includes a communication section 403 which communicates with the server 500 and the communication terminal 70. The management device 400 further includes a charge/discharge instructing section 409 which instructs the station 300 to perform charge/discharge on a particular battery 200 stocked in the station 300, and a writing section 417 which instructs the station 300 to write information received from each component of the management device 400.

When the communication section 403 receives return information from the reading section 401, it obtains, from the communication terminal 70, the location information of the communication terminal 70 at the time when an electronic coupon is displayed on the displaying section 73 of the communication terminal 70, and transmits it to the server 500. The communication section 403 is one example of the managing and transmitting section.

The charge/discharge instructing section 409 instructs the charge/discharge section 305 of the station 300 to charge the battery 200. In this case, the charge/discharge instructing section 409 reads the battery information from each battery 200 stocked in the station 300 via the reading section 401, and refers to the charge/discharge pattern storage section 423 to identify the charge/discharge pattern corresponding to the battery information. The charge/discharge instructing section 409 instructs the charge/discharge section 305 to charge the battery 200 from the electrical power system with the identified charge/discharge pattern.

It is noted that the charge/discharge instructing section 409 may, for example, manage the number of the batteries 200 stocked in the station 300 and the charge amount, so that when it judges that the battery 200 is abundant, it instructs the charge/discharge section 305 to discharge the battery 200 to the electrical power system. In this case, the charge/discharge instructing section 409 reads the battery information from each battery 200 stocked in the station 300 via the reading section 401, and refers to the charge/discharge pattern storage section 423 to identify the charge/discharge pattern corresponding to the battery information. Furthermore, the charge/discharge instructing section 409 instructs the charge/discharge section 305 to discharge the battery 200 to the electrical power system with the identified charge/discharge pattern.

The writing section 417 outputs the instruction to write, to the battery 200 to be lent to the user 60, the usage history information which was read by the reading section 401 from the battery 200 returned by the user 60 to the station 300 and is stored in the history storage section 427. In this case, the writing section 417 may also output the instruction to write, to the battery 200 to be lent to the user 60, the accumulated usage history information stored in the history storage section 427.

The management device 400 further includes a deterioration degree calculating section 411 which calculates the deterioration degree of the battery 200 returned to the station 300, a display judging section 413 which judges the display manner of the deterioration class in the battery 200 based on the deterioration class received from the deterioration degree calculating section 411, and a price judging section 415 which judges the price of the battery 200. The display judging section 413 and the price judging section 415 outputs, to the writing section 417, the judged display manner of the battery 200 and the judged price of the battery, respectively.

Upon receiving the battery ID read by the reading section 401, the deterioration degree calculating section 411 extracts accumulated usage history information stored in the history storage section 427 using the battery ID, and calculates and outputs the deterioration degree indicating the degree of deterioration of the battery 200 based on the extracted accumulated usage history information. It is noted that calculating the deterioration degree of the battery 200 based on the accumulated usage history information includes calculating the deterioration degree based on the accumulated driving history information and calculating the deterioration degree based on the accumulated usage situation history information.

The deterioration degree calculating section 411 refers to the deterioration class condition stored in the condition storage section 425 to judge the deterioration class of the battery 200 based on the calculated deterioration degree of the battery 200 and output the result to the display judging section 413, the price judging section 415, and the writing section 417. The deterioration degree calculating section 411 further judges the change of the deterioration class of the battery 200 and outputs the result to the writing section 417. The deterioration degree calculating section 411 further refers to the condition storage section 425 to judge whether the deterioration degree of the battery 200 during the mount period of the battery 200 is within an appropriate range and output the result to the writing section 417.

The management device 400 further includes a lending processing section 407 which performs a lending process on a particular battery 200 stocked in the station 300. When the lending processing section 407 judges that the battery 200 can be lent, it outputs, to the station 300, the instruction to lend the battery 200.

In this case, when the vehicle ID read by the reading section 401 matches the vehicle ID included in the vehicle ID list stored in the ID list storage section 429, the lending processing section 407 judges that the battery 200 stocked in the station 300 can be lent. Additionally or alternatively, when the user ID read by the reading section 401 matches the user ID included in the user ID list stored in the ID list storage section 429, the lending processing section 407 may judge that the battery 200 can be lent. Furthermore, additionally or alternatively, when the battery ID read by the reading section 401 matches the battery ID included in the battery ID list stored in the ID list storage section 429, the lending processing section 407 may judge that the battery 200 can be lent. It is noted that the lending processing section 407 usually lends the battery 200 in which the charge has completed.

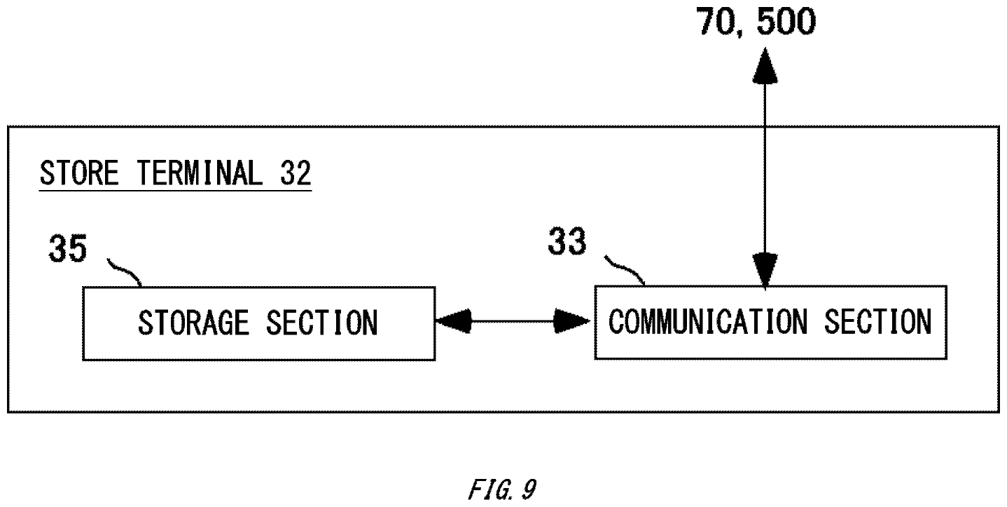

FIG. 9 is a block diagram of the store terminal 32. The store terminal 32 includes a communication section 33 which communicates with the server 500 and the communication terminal 70, and a storage section 35 which stores the record information or the like. When the communication section 33 detects that the user 60 who possesses the communication terminal 70 which received the electronic coupon enters the store 30, for example by receiving, along with the user ID, the probe request broadcasted by the communication terminal 70, it refers to the storage section 35 to transmit, to the server 500, the record information including the information indicating the visit record along with the user ID and the store ID. The store ID is the ID to identify the individual of the store 30. In addition, when the communication section 33 detects that the user purchases a products at the store 30 with an electronic coupon by, for example, presenting the QR code (registered trademark) included in the electronic coupon along with the user ID to the reader of the store terminal 32 to purchase the product, it refers to the storage section 35 to transmit, to the server 500, the record information including the information indicating the purchase record, along with the user ID and the store ID. It is noted that the communication section 33 may also transmit the record information to the management device 400.

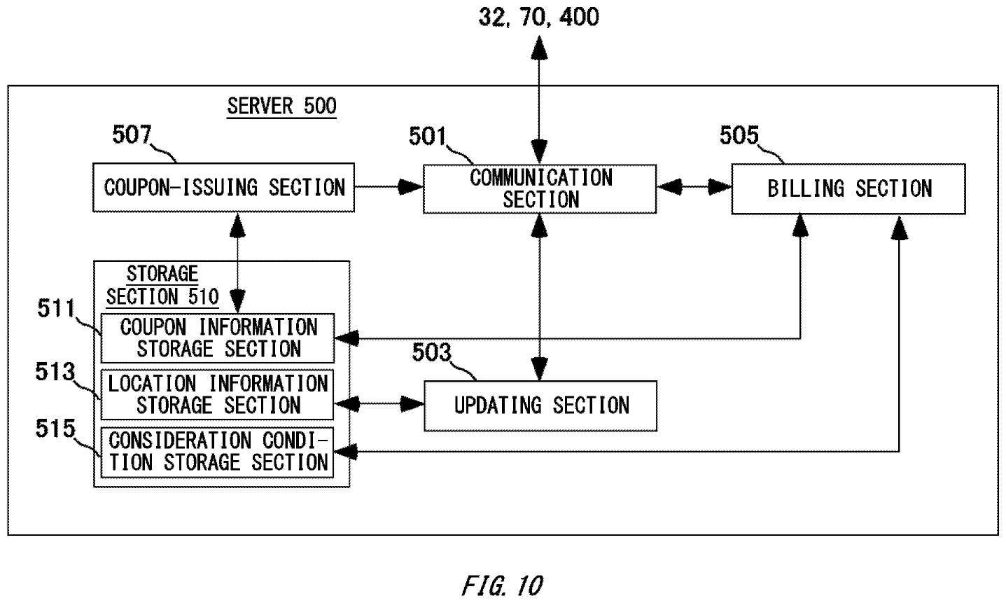

FIG. 10 is a block diagram of the server 500. The server 500 includes a communication section 501 which communicates with the store terminal 32, the communication terminal 70, and the management device 400, a coupon information storage section 511, and a storage section 510 including a location information storage section 513 and a consideration condition storage section 515.

The coupon information storage section 511 stores the information related to the above-mentioned electronic coupon, and associates and stores the user ID and the IP address, the MAC address, the email address, or the like of the communication terminal 70 for all the members. In addition, the coupon information storage section 511 associates and stores the user ID of the member who transmits the electronic coupon and the store ID of the store 30 where the electronic coupon can be used, as the history of the transmitted electronic coupon. In addition, the coupon information storage section 511 associates and stores the store ID of all the stores 30 within the management system 20 and the IP address, MAC address, email address or the like of the store terminal 32. The location information storage section 513 stores the installation location information indicating the information of the installation location where the station 300 is installed. The consideration condition storage section 515 stores the condition according to which the consideration for the effect of attracting users is calculated based on the above-mentioned record information.

The server 500 further includes a coupon-issuing section 507 which refers to the coupon information storage section 511 to issue an electronic coupon and transmit it the communication terminal 70 from the communication section 501. The coupon-issuing section 507 may transmit the electronic coupon to the communication terminal 70 of any user 60 at any timing. For example, the coupon-issuing section 507 may transmit the electronic coupon to the communication terminal 70 of all the members of the management system 20 at a particular time every day, for example at 7 o'clock every morning. In addition, the server 500 may manage the address or the like for all the members, so that it provides the electronic coupon which is likely to be needed by each member, for example by transmitting, to the communication terminal 70 of each member, the electronic coupon of the store 30 in the vicinity of the station 300 near the address of each member. The coupon-issuing section 507 stores the user ID of the user 60 who possesses the communication terminal 70 to which the electronic coupon is transmitted from the communication section 501, in the coupon information storage section 511 as the coupon transmitting history, along with the store ID indicated in the electronic coupon.

The server 500 further includes an updating section 503 which transmits, to the communication terminal 70, the instruction to update the electronic coupon. In this case, when the updating section 503 receives the location information of the communication terminal 70 from the communication section 501, it refers to the location information storage section 513. Then, when it judges that the location information of the communication terminal 70 meets a predetermined condition, it updates the useful information included in the electronic coupon transmitted to the communication terminal 70 to an even more beneficial one for the user 60.

The predetermined condition means that the location of the communication terminal 70 indicated in the location information of the communication terminal 70 at the time when the electronic coupon is displayed on the displaying section 73 of the communication terminal 70 is more than a predetermined distance, for example 3 km, away from the installation location of the station 300. The user 60 who meets such condition can be considered to be a user who follows the intention of the management company, because, even though the user saw the electronic coupon which can be used at the store 30 near the particular station 300 at a location which is, for example, more than 3 km away from the station 300, the user went all the way to the station 300 to exchange the battery 200. Therefore, a high incentive is provided to the user 60.

The server 500 further includes the billing section 505 which, when receiving, from the communication section 501, the record information from the store terminal 32 along with the user ID and the store ID, judges whether the combinations of the user ID and the store ID of the coupon transmitting history stored in the coupon information storage section 511 include them, and, if yes, refers to the consideration condition storage section 515, calculates the consideration for attracting the user 60 to the store 30 based on the stored consideration condition and the record information, and bills the store 30. It is noted that the billing section 505 may refer to the coupon information storage section 511 to bill the destination such as the store terminal 32 of the store 30, the IP address, the MAC address, the email address, or the like for the consideration.

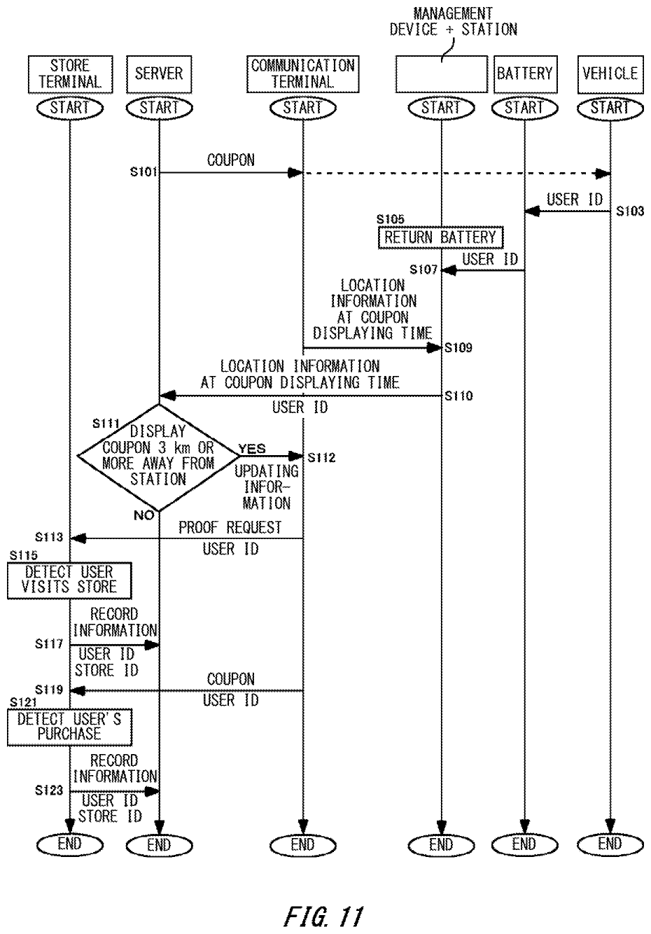

FIG. 11 is a flow diagram according to the first embodiment. When the flow in FIG. 11 starts, the server 500 issues the electronic coupon and transmits it to the communication terminal 70 (S101). When the battery 200 is mounted to the vehicle 100, the vehicle 100 writes the user ID to the battery 200 in advance (S103). When the battery 200 is returned to the station 300 (S105), the management device 400 reads the user ID written to the battery 200 via the station 300 (S107).

The management device 400 communicates with the communication terminal 70 corresponding to the read user ID, obtains the location information of the communication terminal 70 at a time when the electronic coupon is displayed on the displaying section 73 of the communication terminal 70 (S109), and transmits it to the server 500 along with the user ID.

When the server 500 receives the location information of the communication terminal 70 and the user ID, it judges whether the location indicated by the location information of the communication terminal 70 is the location which is more than a predetermined distance, for example 3 km or more, away from the station 300 (S111). In other words, the server judges whether the location where the user 60 who came to return the battery 200 to the station 300 saw, on the own communication terminal 70, the electronic coupon which can be used at the store 30 near the station 300 is a location which is equal to or more than 3 km away from the station 300.

When the user 60 saw the electronic coupon at a location which is equal to or more than 3 km away from the station 300 (S111: YES), the server transmits the update information which updates the useful information included in the electronic coupon which has been already transmitted to the communication terminal 70 of the user 60 to an even more beneficial one for the user 60 (S112). When the user 60 saw the electronic coupon at a location which is less than 3 km away from the station 300 (S111: NO), the server does not transmit the indication information to the communication terminal 70.

The store terminal 32 receives the probe request broadcasted by the communication terminal 70 along with the user ID (S113), thereby detects that the user 60 who possesses the communication terminal 70 visits the store 30 (S115), and transmits, to the server 500, the record information including the information indicating the visit record along with the user ID and the store ID (S117).

When the user 60 uses the electronic coupon stored in the own communication terminal 70 at the store 30 to purchase the products, the store terminal 32 reads the electronic coupon stored in the communication terminal 70 along with the user ID (S119). Thereby, the store terminal 32 detects that the user 60 purchased the products at the store (S121), transmits the record information including the purchase information indicating the purchase record to the server 500 along with the user ID and the store ID (S123), and the flow ends. The flow in FIG. 11 described above is performed repeatedly while each device such as the server 500 operates.

In the above-mentioned embodiment, the server 500 includes a billing section 505 which calculates the consideration for attracting users based on the record information from the store 30, and bills the store 30. Additionally or alternatively, the server 500 may have a calculating section which obtains the record information from the store 30, calculates the consideration for attracting the users to the store 30 based on the record information, calculates the fee to be paid to the store 30 from the station 300 due to the station being installed within the range of the premises of the store, and subtracts the consideration from the fee.

In the above-mentioned embodiment, the SOC calculating section 105 updates the SOC-OCV curve read from the battery 200, and calculates the current SOC of the battery 200 based on the updated SOC-OCV curve and the current voltage of the battery 200 input from the charge/discharge amount measuring section 103. Alternatively, the SOC calculating section 105 may also read the nominal capacitance of the battery 200 measured under a particular condition from the battery 200, measures the current discharge capacity of the battery 200 under the same particular condition, and calculate the SOC as a ratio of the current discharge capacity to the nominal capacitance. Alternatively, the SOC calculating section 105 may read, from the battery 200, the SOC-OCV curve of the battery 200 which is premeasured under a particular condition, measure the current voltage of the battery 200 under the same particular condition and compare it to the SOC-OCV curve to roughly measure the SOC.

In the configuration described in the above-mentioned embodiment, the user 60 who possesses the communication terminal 70 entering the store 30 is detected as a result of the store terminal 32 receiving the probe request broadcasted by the communication terminal 70, along with the user ID. Alternatively, the user 60 who possesses the communication terminal 70 entering the store 30 may be detected as a result of the communication terminal 70 receiving the beacon broadcasted by the store terminal 32 along with the store ID for identifying the individual of the store 30. In this case, the communication terminal 70 transmits the user ID and the store ID to the server 500, as the record information including the information indicating the above-mentioned visit record.

As described above, according to the management system 20 of the present embodiment, the management company which manages the server 500 obtains the record information transmitted from the store 30 to the server 500 so that it can correctly learn the effect of attracting users to the store 30 due to the electronic coupon distributed from the server 500 to the communication terminal 70 of the user 60. Furthermore, by updating the electronic coupon, for example, by increasing the discount rate of the electronic coupon depending on how much the location where the user 60 who came to return the battery 200 to the station 300 saw the electronic coupon is away from the station 300, or the like, the motivation of the user 60 to go to the store 30 near the station 300 after returning the battery 200 to the station 300 can be increased, and the above-mentioned effect of attracting users can be further increased.

The second embodiment is similar to the management system 20 of the first embodiment besides the difference described below, and the overlapped explanation is omitted. The explanation for the configuration of the first embodiment which is the same as that of the second embodiment is omitted.

The server 500 according to the second embodiment is different from the server 500 according to the first embodiment in the following. The server 500 includes a time-predicting section which predicts a time slot during which the battery 200 stocked in the station 300 is abundant at any timing, for example, zero o'clock every night. The updating section 503 of the server 500 transmits the indication information to update the voucher transmitted to the user 60 to an even more beneficial one, to the communication terminal 70 of the user 60 who exchanged the battery 200 in the station 300 at the time slot.

The management device 400 according to the second embodiment is different from the management device 400 according to the first embodiment in the following. Instead of obtaining the location information of the communication terminal 70 and transmitting it to the server 550, the communication section 403 transmits the return information, which indicates that the battery 200 has been returned to the station 300, to the server 500. In addition, in the history storage section 427 of the management device 400, exchange history information is stored, which indicates the history of exchanges of the battery 200 at the station 300. The reading section 401 of the management device 400 transmits new exchange history information stored in the history storage section 427 from the communication section 403 to the server 500 at any timing before the server 500 performs the above-mentioned predict, for example at 23 o'clock every night.

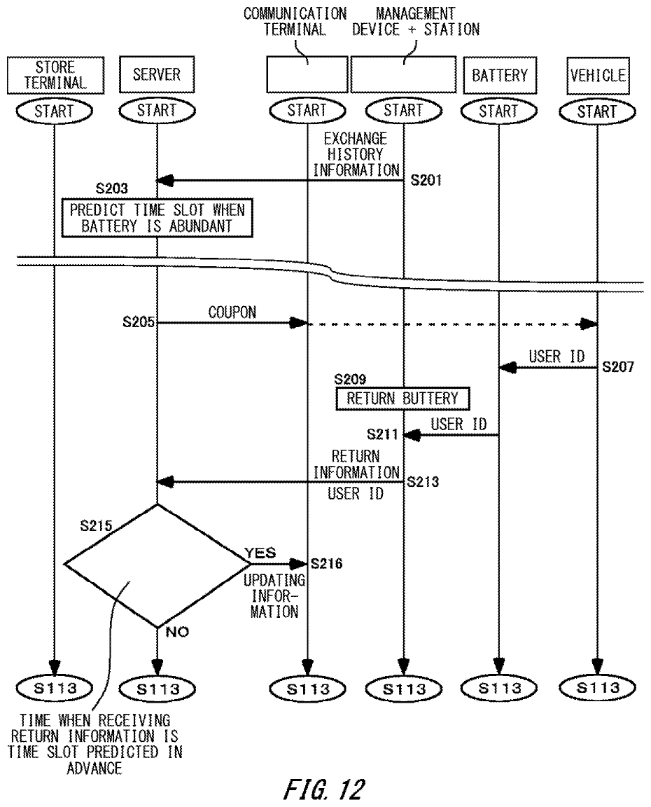

FIG. 12 is a flow diagram according to the second embodiment. When the flow in FIG. 12 starts, the management device 400 transmits the exchange history information to the server 500 (S201), and then the server 500 predicts the time slot during which the number of the batteries 200 stocked in the station 300 is larger than a predetermined number based on the obtained exchange history information (S203).

The server 500 issues the electronic coupon and transmits it to the communication terminal 70 (S205). While the battery 200 is mounted to the vehicle 100, the vehicle 100 writes the user ID to the battery 200 in advance (S207). When the battery 200 is returned to the station 300 (step 209), the management device 400 reads the user ID written to the battery 200 via the station 300 (S211).

The management device 400 transmits the return information to the server 550 along with the user ID (S213), and then the server 500 judges whether the time when the return information is received from the management device 400 is in the predicted time slot described above (S215).

If the above-mentioned time is in the predicted time slot (S215: YES), the server transmits, to the communication terminal 70, the update information which is the instruction to update the useful information included in the electronic coupon transmitted to the communication terminal 70 to an even more beneficial one for the user 60 (S216), and the flow moves to S113 explained in FIG. 11. On the other hand, if the time is not in the predicted time slot (S215: NO), the server 550 does not transmit the update information to the communication terminal 70, and the flow moves to S113.

As described above, according to the present embodiment, the time slot during which the number of the batteries 200 stocked in the station 300 is larger than a predetermined number is predicted, and the electronic coupon transmitted to the user 60 is updated to an even more beneficial one for the user 60, for the user 60 who exchanges the battery 200 in the station 300 at the time slot. This increases the motivation of the user 60 who received the benefit from the update of the electronic coupon to go to the station 300 to exchange the battery 200 at the same time slot, that is, at the time slot during which the battery 200 is abundant in the station 300, to receive the same benefit repeatedly. As a result, even in the time slot during which the number of the users 60 who borrow the battery 200 at the station 300 is small, the users 60 go to exchange the battery 200 to receive the benefit as described above, improving the effect of attracting users to the store 30. In addition, among a plurality of stores 30 near the station 300, the electronic coupon of the store 30 which is open in the predicted time slot as described above can be selectively distributed.

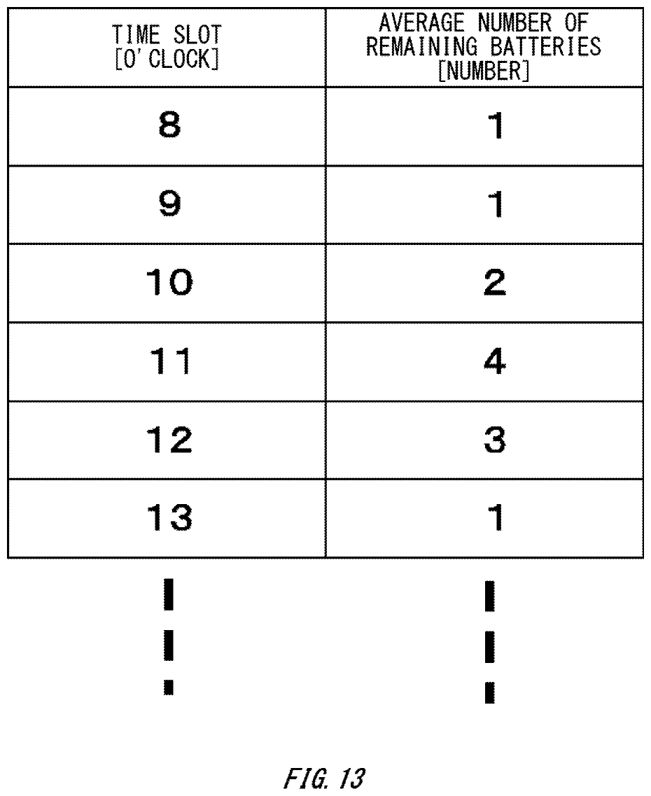

FIG. 13 is one example of a table of the exchange history information stored in the history storage section 427 of the management device 400 according to the third embodiment. The management device 400 and the server 500 according to the third embodiment additionally includes a setting section which sets, to the electronic coupon, an expiration time corresponding to the time slot predicted by the above-mentioned time-predicting section, unlike the management device 400 and the server 500 according to the second embodiment. In addition, the above-mentioned coupon-issuing section 507 transmits the electronic coupon having the expiration time set by the setting section from the communication section 501 to the communication terminal 70.

The table shown in FIG. 13 stores two items, that is, the time slot [o'clock] and the average number of the remaining batteries [number] during any period, separately in each of the two columns. As shown in FIG. 13, in the present embodiment, the history storage section 427 of the management device 400 stores the table of the exchange history information of the battery 200 at a particular station 300, for example in any period, for example, in the last month. In this case, the time-predicting section may predict that the batteries 200 will become abundant at the particular station 300 in a period between 10 o'clock and 12 o'clock based on the table.

As described above, according to the present embodiment, because an electronic coupon having an expiration time corresponding to the predicted time slot during which the batteries 200 are abundant in the station 300 is issued so that, for example, the user 60 who wants to use the electronic coupon is encouraged to exchange the battery 200 at the station 300 in the predicted time slot during which the batteries 200 are abundant, the user 60 goes to exchange the battery 200 to receive the benefit of the updating of the electronic coupon even in the time slot during which the number of the users 60 who borrow the battery 200 is small, improving the effect of attracting users to the store 30 more effectively than the management system 20 according to the second embodiment described above.

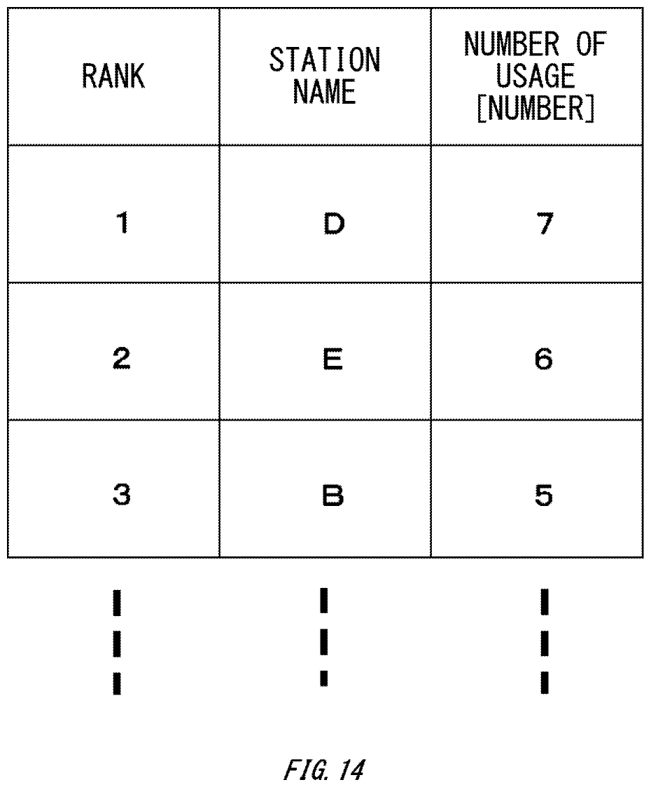

FIG. 14 is one example of a table of the station history information stored in the station history storage section 216 of the battery 200 according to the fourth embodiment. In the present embodiment, it is assumed that usage history information in a mount period to the vehicle 100 used by the user 60 who returned the battery 200, stored in the battery 200 returned to the station 300, is read by the management device 400 and written to the battery 200 which is to be lent to the user 60, that is, the usage history information related to the user 60 or the vehicle 100 is succeeded. The station history information shown in FIG. 14 is also the accumulated information which has been succeeded among a plurality of batteries 200 for a particular user 60. The table shown in FIG. 14 stores three items, that is, the rank, the station name, and the number of usage [number of times], separately in each of three columns. The table stores the station name and the number of usage which are sorted in the descending order of the number of usage.

In addition to or instead of the management device 400 according to the first embodiment, the management device 400 according to the fourth embodiment transmits, to the server 570, the station history information which is unique to the user 60 and which is read from the battery 200 returned by the particular user 60 to the station 300. The server 500 according to the fourth embodiment also includes a station predicting section which, based on the station history information which is unique to a particular user 60 and which is received form the management device 400, predicts the station 300 utilized by the user 60. The server and the above-mentioned coupon-issuing section 507 issue the electronic coupon which encourages the user 60 to visit the store 30 within a predetermined distance range from the predicted station 300, and transmit it to the user 60. In the example of the station history information shown in FIG. 14, the predicted station 300 is, for example, station D, which is at rank 1 and has the largest number of usage.

As described above, according to the present embodiment, because an electronic coupon which can be used at the store 30 near the station 300 which is frequently utilized by each user 60 is issued separately based on the utilization tendency of the station by each user 60, the electronic coupon which is expected to be needed by each user 60 can be distributed with no waste, increasing the utilization rate of the electronic coupon by the user 60.

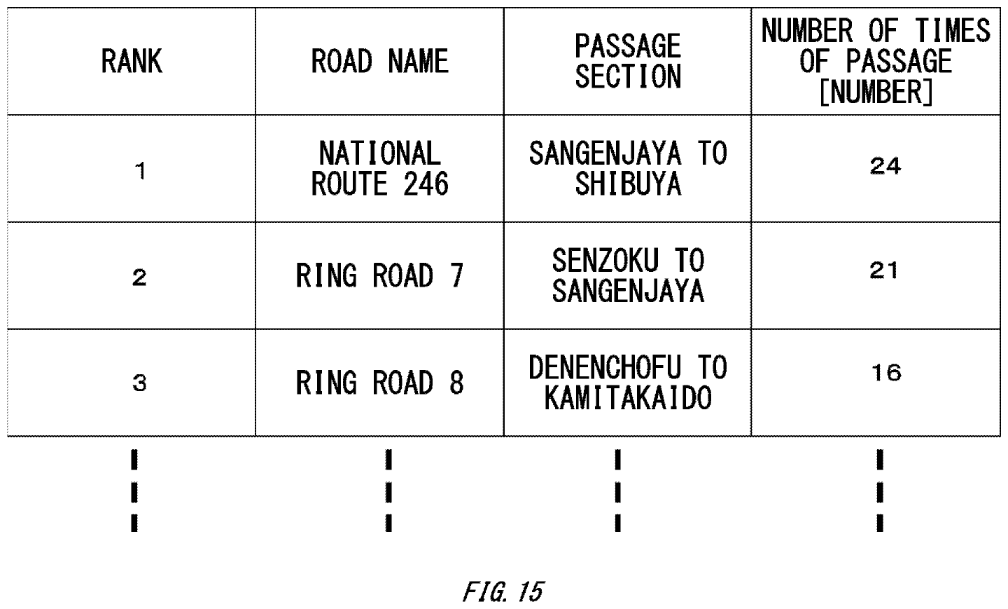

FIG. 15 is one example of the table of the path history information stored in the driving history storage section 213 of the battery 200 according to the fifth embodiment. The table of the driving history information according to the present embodiment stores four items, that is, the rank, the road name, the passage section, and the number of passage [number of times], separately in each of the four columns, unlike the example of the table of the driving history information in the first embodiment shown in FIG. 4. The table stores the road name, the passage section, and the number of passage which are sorted in the descending order of the number of passage. In the present embodiment, it is also assumed that the driving history information related to the user 60 or the vehicle 100 is succeeded between the returned battery and the lent battery.

The management device 400 and the server 500 according to the fifth embodiment are different from the management device 400 and the server 500 according to the fourth embodiment in that the management device 400 additionally or alternatively transmits, to the server 580, the path history information read from the battery 200 returned to the station, and the server 580 further includes a route-predicting section which predicts a path along which the vehicle 100 will travel based on the path history information. The server 500 issues an electronic coupon which encourages the user 60 to visit the store 30 which is less than a predetermined distance, for example 1 km or less, away from the path along which the vehicle 100 will travel, predicted by the route-predicting section, and transmits it to the communication terminal 70 of the user 60. For example, based on the day of the week and time indicated in the driving history information stored in the battery 200 returned to the station 300 by the user 60 who possesses the communication terminal 70, a particular road section along which the user 60 drives the vehicle 100 in the morning of the weekday may be predicted so that an electronic coupon which encourages the visit to the store 30 located along the road in the road section may be transmitted to the communication terminal 70 of the user 60 at night on Sunday.

As described above, according to the present embodiment, the effect similar to the effect of the fourth embodiment described above can be achieved.

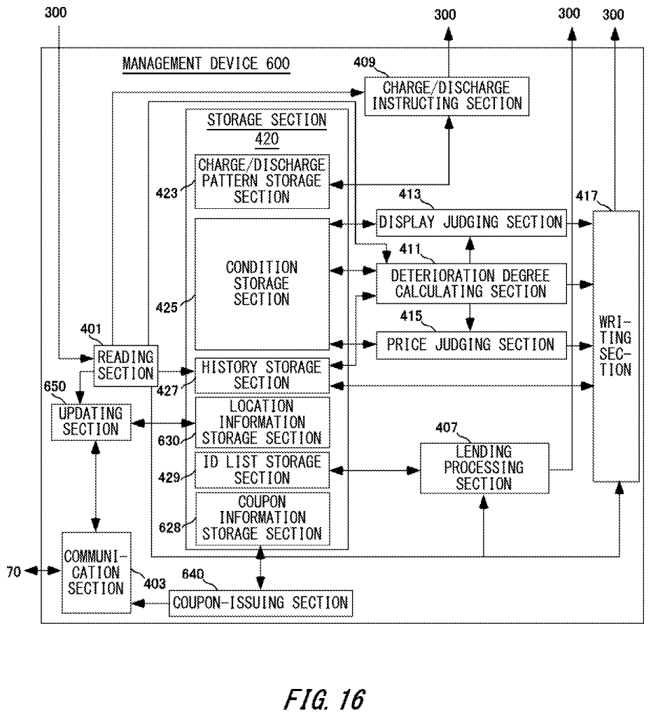

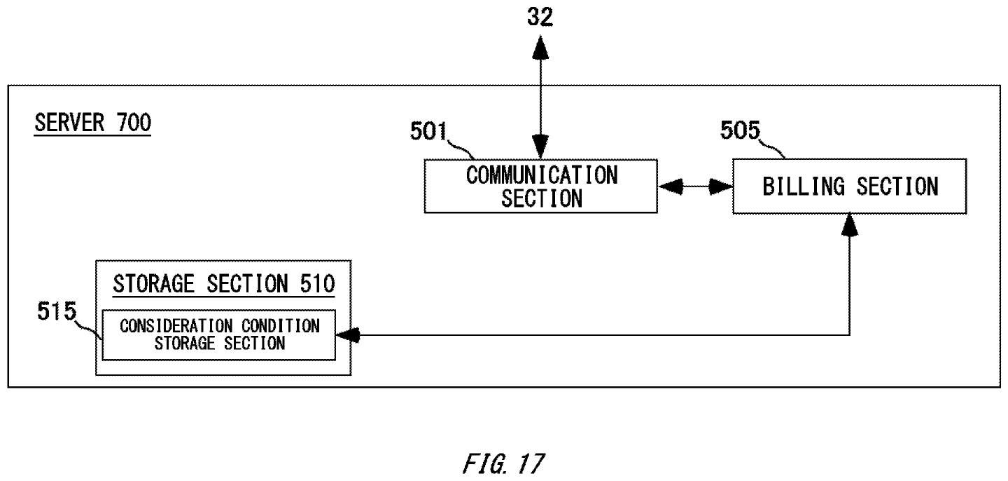

FIG. 16 is a block diagram of the management device 600 according to the sixth embodiment, and FIG. 17 is a block diagram of the server 700 according to the sixth embodiment. In FIG. 16 and FIG. 17, the same configurations as that of FIG. 1 to FIG. 11 used for explaining the first embodiment are attached with the same reference number, and the explanation is omitted.

As shown in FIG. 16 and FIG. 17, the server 700 in the present embodiment does not include the coupon-issuing section 507, the updating section 503, the location information storage section 513, and the coupon information storage section 511 that the server 500 in the first embodiment has, but instead the management device 600 includes a coupon-issuing section 640, an updating section 650, a location information storage section 630, and a coupon information storage section 628. The configurations in the present embodiment with the same name as those of the first embodiment have the same functions and the similar information flow, and the explanation is omitted. It is noted that the consideration condition storage section 515 of the server 700 may associate and store the above-mentioned coupon transmitting history and the store ID of all the stores 30 in the management system 20, and the IP address, the MAC address, the email address, or the like of the store terminal 32.

As described above, according to the present embodiment, the effect similar to the effect of the first embodiment described above can be achieved.

In the above-mentioned sixth embodiment, the management device 600 may further include a time-predicting section which predicts the time slot during which the number of the batteries 200 stocked in the station 300 is larger than a predetermined number based on the exchange history information indicating the history of exchanges of the battery 200 in the station 300, and the coupon-issuing section 640 may set the expiration time corresponding to the time slot predicted in the time-predicting section to the electronic coupon and transmit the electronic coupon with the expiration time from the communication section 501 to the communication terminal 70.

In the above-mentioned sixth embodiment, the management device 600 may also further include an adjusting section which transmits, from the communication section 403 to the communication terminal 70, the instruction to adjust the useful information included in the electronic coupon transmitted to the communication terminal 70, based on the usage history information read by the reading section 401 from the battery 200 returned to the station 300. In this case, the management device 600 may also further include a standard storage section which stores the reference information indicating the reference range of the usage amount of the battery 200, and the above-mentioned adjusting section may refer to the standard storage section, and, when judging that the usage amount of the battery 200 indicated in the usage history information read by the reading section 401 is within a reference range, transmit, from the communication section 403 to the communication terminal 70, the instruction to update the useful information included in the electronic coupon transmitted to the communication terminal 70 to an even more beneficial one for the user.

In the above-mentioned sixth embodiment, the management device 600 may also further include a determining section which obtains the stock number information indicating the number of the batteries 200 stocked in the station 300 and determines the number of issuance of the electronic coupon depending on the number of the batteries 200 indicated in the stock number information, and the coupon-issuing section 640 may issue the electronic coupon according to the number of issuance determined by the determining section and transmit it to the communication terminal 70.

From the first embodiment to the fifth embodiment described above, the electronic coupon may, in response to being displayed on the displaying section of the communication terminal, be additionally or alternatively configured to be associated with the location information at a present time obtained by the obtaining section of the communication terminal and be transmitted from the communication section of the communication terminal to the server. In this case, the reading section of the management device may detect that the user has returned the battery to the station and output the return information, and the communication section of the management device may transmit, to the server, the return information received from the reading section. In this case, the server may have a location information storage section which stores the installation location information of the station and an updating section which, upon receiving the return information from the management device, refers to the location information storage section, and, when judging that the location of the communication terminal indicated in the location information associated with the electronic coupon received from the communication terminal is more than a predetermined distance away from the installation location of the station, transmits, from the communication section to the communication terminal, the instruction to update the useful information included in the electronic coupon transmitted to the communication terminal to an even more beneficial one for the user.

From the first embodiment to the fifth embodiment described above, the communication section of the management device may further read the usage history information from the battery used in the vehicle and returned by the user to the station via the reading section and transmit it to the server. In this case, the server may have an adjusting section which transmits, from the server-side transmitting section to the communication terminal, the instruction to adjust the useful information included in the electronic coupon transmitted to the communication terminal based on the usage history information received from the management device. In this case, the updating section of the server further has a standard storage section which stores the reference information indicating the reference range of the usage amount of the battery, and the above-mentioned adjusting section refers to the standard storage section, and, when judging that the usage amount of the battery indicated in the usage history information received from the management device is within a reference range, and transmits, from the communication section to the communication terminal, the instruction to update the useful information included in the electronic coupon transmitted to the communication terminal to an even more beneficial one for the user.

From the first embodiment to the fifth embodiment described above, the server may further include a determining section which receives the stock number information indicating the number of the batteries stocked in the station from the management device and determines the number of issuance of the electronic coupon depending on the number of the batteries indicated in the stock number information, and the coupon-issuing section may issue an electronic coupon according to the number of issuance determined by the determining section.

In any of the above-mentioned embodiments, the battery may be any type of a battery which can be charged/discharged, for example, all solid battery, lithium-ion battery, or the like. Furthermore, in any of the above-mentioned embodiments, an emergency battery may be provided as a buffer in the station. The emergency battery may be, for example, an old battery which cannot be used as a battery for lending due to a high deterioration degree. The station may also be provided with a power generator for generating renewable energy such as solar ray.

In any of the above-mentioned embodiments, the vehicle may communicate with either or both of the management device and the server via the communication network.

In any of the above-mentioned embodiments, the battery-accommodating section of the station may be configured to retain the batteries which can be moved therein, and eject a battery from an outlet based on the input from the outside.

Various embodiments of the present invention may be described with reference to flowcharts and block diagrams whose blocks may represent (1) steps of processes in which operations are performed or (2) sections of devices responsible for performing operations. Certain steps and sections may be implemented by dedicated circuitry, programmable circuitry supplied with computer-readable instructions stored on computer-readable media, and/or processors supplied with computer-readable instructions stored on computer-readable media. Dedicated circuitry may include digital and/or analog hardware circuits and may include integrated circuits (IC) and/or discrete circuits. Programmable circuitry may include reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

Computer-readable media may include any tangible device that can store instructions for execution by a suitable device, such that the computer-readable medium having instructions stored therein comprises an article of manufacture including instructions which can be executed to create means for performing operations specified in the flowcharts or block diagrams. Examples of computer-readable media may include an electronic storage medium, a magnetic storage medium, an optical storage medium, an electromagnetic storage medium, a semiconductor storage medium, etc. More specific examples of computer-readable media may include a floppy (registered trademark) disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a compact disc read-only memory (CD-ROM), a digital versatile disk (DVD), a BLU-RAY (registered trademark) disc, a memory stick, an integrated circuit card, etc.

Computer-readable instructions may include assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, JAVA (registered trademark), C++, etc., and conventional procedural programming languages, such as the “C” programming language or similar programming languages.

Computer-readable instructions may be provided to a processor of a general purpose computer, special purpose computer, or other programmable data processing apparatus, or to programmable circuitry, locally or via a local area network (LAN), wide area network (WAN) such as the Internet, etc., to execute the computer-readable instructions to create means for performing operations specified in the flowcharts or block diagrams. Examples of processors include computer processors, processing units, microprocessors, digital signal processors, controllers, microcontrollers, etc.

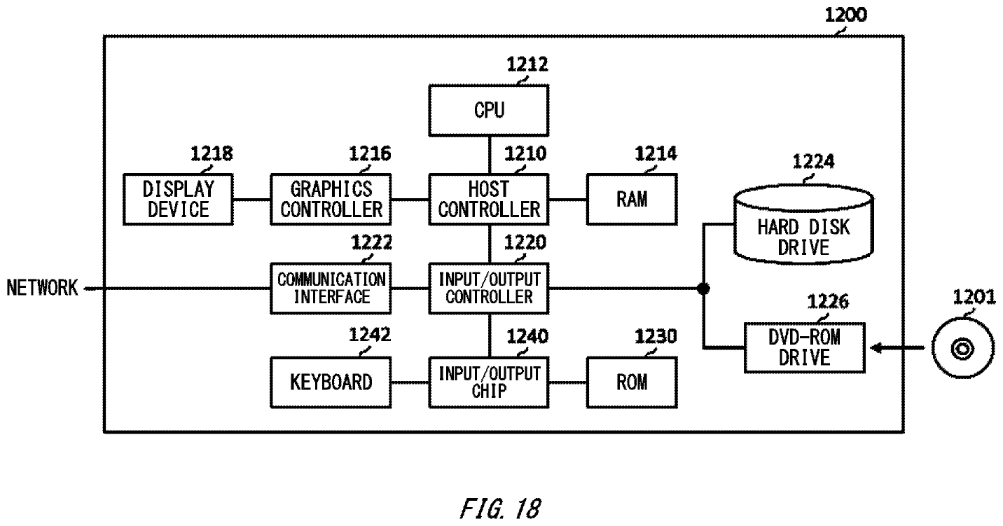

FIG. 18 shows an example of the computer 1200 which can realize a plurality of aspects of the present invention entirely or partially. A program installed on the computer 1200 can cause the computer 1200 to function as an operation associated with an apparatus according to embodiments of the present invention or as one or more “unit(s)” of the apparatus, or to perform the operation or the one or more “unit(s)”, and/or can cause the computer 1200 to perform processes according to embodiments of the present invention or steps of the processes. Such a program may be executed by a CPU 1212 to cause the computer 1200 to perform particular operations associated with some or all blocks in the flowcharts or block diagrams described herein.

The computer 1200 according to the present embodiment includes a CPU 1212, a RAM 1214, a graphics controller 1216 and a display device 1218, which are connected to each other by a host controller 1210. The computer 1200 also includes input/output units such as a communication interface 1222, a hard disk drive 1224, a DVD-ROM drive 1226 and an IC card drive, which are connected to the host controller 1210 via an input/output controller 1220. The computer also includes legacy input/output units such as a ROM 1230 and a keyboard 1242, which are connected to the input/output controller 1220 via an input/output chip 1240.

The CPU 1212 operates in accordance with programs stored in the ROM 1230 and the RAM 1214, and controls each unit accordingly. The graphics controller 1216 acquires image data generated by the CPU 1212 on a frame buffer or the like provided in the RAM 1214 or in the graphics controller 1216 itself, and displays the image data on the display device 1218.

The communication interface 1222 communicates with other electronic devices via a network. The hard disk drive 1224 stores programs and data to be used by the CPU 1212 in the computer 1200. The DVD-ROM drive 1226 reads programs or data from the DVD-ROM 1201, and provides the programs or data to the hard disk drive 1224 via the RAM 1214. The IC card drive reads programs and data from an IC card and/or writes programs and data into the IC card.

The ROM 1230 has stored therein a boot program or the like to be executed by the computer 1200 at the time of activation, and/or a program that depends on the hardware of the computer 1200. The input/output chip 1240 may also connect various input/output units to the input/output controller 1220 via a parallel port, a serial port, a keyboard port, a mouse port or the like.

Programs are provided by a computer-readable storage medium such as the DVD-ROM 1201 or an IC card. The programs are read from the computer-readable storage medium, installed on the hard disk drive 1224, the RAM 1214 or the ROM 1230, which are also examples of a computer-readable storage medium, and executed by the CPU 1212. The information processing described in the programs is read into the computer 1200, resulting in cooperation between the programs and the above various types of hardware resources. An apparatus or method may be constituted by implementing the operation or processing of information in accordance with the use of the computer 1200.

For example, if a communication is performed between the computer 1200 and external devices, the CPU 1212 may execute a communication program loaded on the RAM 1214, and instruct the communication interface 1222 to perform communication process based on the process described in the communication program. Under the control of the CPU 1212, the communication interface 1222 reads transmission data stored in a transmission buffer region provided in a recording medium such as the RAM 1214, the hard disk drive 1224, the DVD-ROM 1201 or an IC card, and sends the read transmission data to the network, or writes reception data received from the network into a reception buffer region or the like provided in the recording medium.

The CPU 1212 may also make all or required portions of the files or databases stored in an external recording medium such as the hard disk drive 1224, the DVD-ROM drive 1226 (DVD-ROM 1201) or an IC card to be read by the RAM 1214, and perform various types of processing on the data on the RAM 1214. Then, the CPU 1212 may write back the processed data to the external recording medium.

Various types of information such as various types of programs, data, tables and databases may be stored in the recording medium for information processing. The CPU 1212 may perform various types of processing on the data read from the RAM 1214, which includes various types of operations, information processing, condition judging, conditional branch, unconditional branch, search/replacement of information, etc., as described throughout this disclosure and specified by an instruction sequence of programs, and writes the result back to the RAM 1214. In addition, the CPU 1212 may search for information in a file, a database, etc., in the recording medium. For example, when a plurality of entries, each having an attribute value of a first attribute associated with an attribute value of a second attribute, are stored in the recording medium, the CPU 1212 may search the plurality of entries for an entry whose attribute value of the first attribute matches a designated condition, read the attribute value of the second attribute stored in the entry, and thereby acquire the attribute value of the second attribute associated with the first attribute that meets a predetermined condition.

The programs or software modules in the above description may be stored on the computer 1200 or a computer-readable storage medium near the computer 1200. Further, a recording medium such as a hard disk or a RAM provided in a server system connected to a dedicated communication network or the Internet can be used as a computer-readable storage media, which provides programs to the computer 1200 via the network.

While the embodiments of the present invention have been described, the technical scope of the invention is not limited to the above described embodiments. It is apparent to persons skilled in the art that various alterations or improvements can be added to the above-described embodiments. Also, matters explained with reference to a particular embodiment can be applied to other embodiments as long as such application does not cause a technical contradiction. Also, each component may have similar features to another component having the same name and a different reference number. It is also apparent from the scope of the claims that the embodiments added with such alterations or improvements can be included in the technical scope of the invention.

The operations, procedures, steps, and stages of each process performed by an apparatus, system, program, and method shown in the claims, specification, or diagrams can be performed in any order as long as the order is not indicated by “prior to,” “before,” or the like and as long as the output from a previous process is not used in a later process. Even if the process flow is described using phrases such as “first” or “next” in the claims, specification, or diagrams, it does not necessarily mean that the process must be performed in this order.

### EXPLANATION OF REFERENCES

20 management system
30 store
32 store terminal
33 communication section
35 storage section
40 communication network
60 user
70 communication terminal
71 communication section
73 displaying section
75 storage section
77 location-information obtaining section
100 vehicle
101 battery-accommodating section
103 charge/discharge amount measuring section
105 SOC calculating section
107 battery temperature measuring section
109 regenerative electric power charge section
111 location-information obtaining section
112 date and time measuring section
113 acceleration measuring section
115 travel time measuring section
117 travel distance measuring section
119 driving disposition judging section
120 storage section
121 condition storage section
122 user-related information storage section
123 vehicle ID storage section
126 vehicle-related information storage section
200 battery
210 storage section
211 usage history information storage section
213 driving history storage section
215 usage situation history storage section
216 station history storage section
217 battery information storage section
219 related information storage section
221 user-related information storage section
223 vehicle-related information storage section
300 station
301 battery-accommodating section
303 reading/writing section
305 charge/discharge section
307 displaying section
309 input section
400 management device
401 reading section
403 communication section
407 lending processing section
409 charge/discharge instructing section
411 deterioration degree calculating section
413 display judging section
415 price judging section
417 writing section
420 storage section
423 charge/discharge pattern storage section
425 condition storage section
427 history storage section
429 ID list storage section
500, 700 server
501 communication section
503 updating section
505 billing section
507 coupon-issuing section
510 storage section
511 coupon information storage section
513 location information storage section
515 consideration condition storage section
628 coupon information storage section
630 location information storage section
640 coupon-issuing section
650 updating section
1200 computer
1201 DVD-ROM
1210 host controller
1212 CPU
1214 RAM
1216 graphics controller
1218 display device
1220 input/output controller
1222 communication interface
1224 hard disk drive
1226 DVD-ROM drive
1230 ROM
1240 input/output chip
1242 keyboard

What is claimed is:

1. A management system, comprising:
a store terminal provided in a store which sells products;
a management device which is disposed in a station installed within a predetermined distance range from the store and which is configured to manage a battery detachable to a vehicle which is electrically driven, wherein the battery is exchanged in the station;
a user terminal which is possessed by a user of the vehicle; and
a server which communicates with the management device and the user terminal; wherein
the server has a server-side transmitting section which is configured to transmit, to the user terminal, an electronic coupon including useful information which is beneficial for the user, wherein the electronic coupon encourages the user to visit the store;
the store terminal has a store-side transmitting section which is configured to, when detecting that the user who possesses the user terminal which received the electronic coupon visits the store, transmit, to at least one of the server and the management device, record information including information indicating a visit record;
the user terminal comprising:
an obtaining section which is configured to obtain location information indicating a location of the user terminal; and
a displaying section which is configured to display the electronic coupon received from the server, in response to an operation by the user,
the server further comprising:
a location information storage section which is configured to store installation location information indicating information of an installation location where the station is installed; and
an updating section which is configured to refer to the location information storage section, and, when judging that a location of the user terminal indicated in the location information at a time when the electronic coupon is displayed on the displaying section is more than a predetermined distance away from the installation location of the station, transmit, from the server-side transmitting section to the user terminal, an instruction to update the useful information included in the electronic coupon transmitted to the user terminal to an even more beneficial one for the user.

2. The management system according to claim 1, wherein the management device comprises:
a detecting section which is configured to detect that the user who possesses the user terminal has returned the battery used in the vehicle to the station in order to exchange the battery with the battery stocked in the station, and output return information indicating that the battery has been returned; and
a managing and transmitting section which is configured to, when receiving the return information from the detecting section, obtain, from the user terminal, the location information of the user terminal at a time when the electronic coupon is displayed on the displaying section of the user terminal, and transmit the location information to the server.

3. The management system according to claim 1, wherein the management device comprises:
a detecting section which is configured to detect that the user who possesses the user terminal has returned the battery used in the vehicle to the station in order to exchange the battery with the battery stocked in the station, and output return information indicating that the battery has been returned; and
a managing and transmitting section which is configured to transmit, to the server, the return information received from the detecting section, wherein
the electronic coupon is configured to be associated with the location information at a present time obtained by the obtaining section of the user terminal and be transmitted from a communication section of the user terminal to the server, in response to the electronic coupon being displayed on the displaying section of the user terminal.

4. A server which is configured to communicate with a management device and a user terminal, the management device being configured to manage a battery detachable to a vehicle which is electrically driven, and the user terminal being possessed by a user of the vehicle, wherein
the management device is disposed in a station where the battery is exchanged and which is installed within a predetermined distance range from a store which sells products,
the server comprising:
a time-predicting section which is configured to receive, from the management device, exchange history information indicating a history of exchanges of the battery at the station and predict a time slot during which a number of the battery stocked in the station is larger than a predetermined number, based on the exchange history information;
a setting section which is configured to set an expiration time corresponding to the time slot predicted by the time-predicting section to an electronic coupon including useful information which is beneficial for the user, wherein the electronic coupon encourages the user to visit the store; and
a transmitting section which is configured to transmit, to the user terminal, the electronic coupon to which the expiration time is set by the setting section.

5. A server which is configured to communicate with a management device and a user terminal, the management device being configured to manage a battery detachable to a vehicle which is electrically driven, and the user terminal being possessed by a user of the vehicle, wherein
the management device is disposed in a station where the battery is exchanged and which is installed within a predetermined distance range from a store which sells products, and
the battery used in the vehicle has usage history information written thereto, which indicates how the battery has been used during a period from a moment when the battery was mounted to the vehicle to a moment when the battery was removed,
the server comprising:
a transmitting section which is configured to transmit, to the user terminal, an electronic coupon including useful information which is beneficial for the user, wherein the electronic coupon encourages the user to visit the store; and
an adjusting section which is configured to receive, from the management device, the usage history information read by a battery used in the vehicle and returned by the user to the station in order to exchange the battery with the battery stocked in the station and transmit, from the transmitting section to the user terminal, an instruction to adjust the useful information included in the electronic coupon transmitted to the user terminal, based on the usage history information.

6. The server according to claim 5, further comprising a standard storage section which is configured to store reference information indicating a reference range of a usage amount of the battery, wherein
the adjusting section is configured to refer to the standard storage section, and, when judging that the usage amount of the battery indicated in the usage history information received from the management device is within the reference range, transmit, from the transmitting section to the user terminal, an instruction to update the useful information included in the electronic coupon transmitted to the user terminal to an even more beneficial one for the user.

7. A server which is configured to communicate with a management device and a user terminal, the management device being configured to manage a battery detachable to a vehicle which is electrically driven, and the user terminal being possessed by a user of the vehicle, wherein
the management device is disposed in a station where the battery is exchanged and which is installed within a predetermined distance range from a store which sells products,
the server comprising:
a determining section which is configured to receive, from the management device, stock number information indicating a number of the battery stocked in the station, and determine a number of issuance of an electronic coupon including useful information which is beneficial for the user depending on the number of the battery indicated in the stock number information, wherein the electronic coupon encourages the user to visit the store; and
a transmitting section which is configured to issue the electronic coupon according to the number of issuance which is determined by the determining section and transmit the electronic coupon to the user terminal.

8. A management system, comprising:
a store terminal provided in a store which sells products;
a management device which is disposed in a station installed within a predetermined distance range from the store and which is configured to manage a battery detachable to a vehicle which is electrically driven, wherein the battery is exchanged in the station;
a user terminal possessed by a user of the vehicle; and
a server which is configured to communicate with the management device and the user terminal, wherein
the server has a server-side transmitting section which is configured to transmit, to the user terminal, an electronic coupon including useful information which is beneficial for the user, wherein the electronic coupon encourages the user to visit the store,
the store terminal has a store-side transmitting section which is configured to, when detecting that the user who possesses the user terminal which received the electronic coupon visits the store, transmit, to at least one of the server and the management device, record information including information indicating a visit record,
the management device further includes:
a history storage section which is configured to store exchange history information indicating a history of exchanges of the battery at the station; and
a managing and transmitting section which is configured to obtain the exchange history information from the history storage section and transmit the exchange history information to the server
the server further has a time-predicting section which is configured to predict a time slot during which a number of the battery stocked in the station is larger than a predetermined number based on the exchange history information received from the management device, and
the server-side transmitting section is configured to transmit the electronic coupon based on the time slot predicted by the time-predicting section.

9. The management system according to claim 8, wherein the management device further includes a detecting section which is configured to detect that the user who possesses the user terminal returns the battery used in the vehicle to the station in order to exchange the battery with the battery stocked in the station, and output the return information indicating that the battery has been returned,
the managing and transmitting section is configured to transmit, to the server, the return information received from the detecting section, and
the server further has an updating section which is configured to, when judging that a time when the return information is received from the management device is in the time slot predicted by the time-predicting section, transmit, from the server-side transmitting section to the user terminal, an instruction to update the useful information included in the electronic coupon transmitted to the user terminal to an even more beneficial one for the user.

10. The management system according to claim 8, wherein the server further has a setting section which is configured to set an expiration time corresponding to the time slot predicted by the time-predicting section to the electronic coupon.
